(19) United States
(12) Patent Application Publication
(10) Pub. No.: US 2014/0258066 A1
(43) Pub. Date: Sep. 11, 2014

(54) Method for Automating Trend Qualification and Anchored Support/Resistance

(71) Applicant: Leslie Allen Little, Morrison, CO (US)

(72) Inventor: Leslie Allen Little, Morrison, CO (US)

(21) Appl. No.: 13/788,698

(22) Filed: Mar. 7, 2013

(51) Int. Cl. G06Q 40/04

(52) U.S. Cl. CPC G06Q 40/04
USPC 705/37

(57) ABSTRACT

A method for determining swing points on any and all unfettered exchanges where price and volume data are collected and published. A method for determining support and resistance bars from the same data source. A process whereby swing points and support and resistance bars are examined to determine and qualify trends, to create support and resistance anchor zones, trend and trade probability failure rates, trading signals and derivative indicators based on qualified trend. Methods for the displaying this information through a trading cube, neoclassical charts, trend transition tables, and support and resistance zones.

### CROSS REFERENCE TO RELATED APPLICATION

This application claims the benefit of U.S. Provisional Application No. 61/607,826, filed Mar. 7, 2012, which is incorporated herein by reference.

### FIELD OF INVENTION

Financial and technical trading application software.

### BACKGROUND

To date, many varied software applications exist to examine market data and to project price action based on the historical data. Historical data available for almost all exchanges consists of a trading instrument's symbol, an opening price, the high, low and the close as well as volume for the time period examined. In those cases where there is an inherent hierarchy of sector and general market classifications in the data, then these two data elements are also available. An examination of the basic data elements (symbol, opening price, high, low, close, volume, and a hierarchical classification and grouping of each symbol into larger sectors and markets) reveals three basic data types. They are time, volume and price.

All existing applications that are focused on trend identification and transitions utilize one and, at most, two of the basic data types. The same is true for support and resistance zones. In both cases, price data is by far the most common basic data type utilized.

As an example, for trend determination and transition the Average Directional Movement Index (ADX) uses price only (highs and lows) to determine the strength or weakness of a trend. Another trend reversal algorithm is Parabolic SAR which also uses price data only (highs and lows). Other algorithms that are related to trend in an auxiliary way such as the Relative Strength Index computes momentum (a form of trend) as the ratio of higher closes to lower closes: stocks which have had more or stronger positive changes have a higher RSI than stocks which have had more or stronger negative changes.

For support and resistance, existing algorithms also focus almost exclusively on price. Bollinger Bands provide a good example. Their algorithmic calculation creates two price bands that are N standard deviations off a moving average. The moving average is based on the closing price. Other methods involve the use of trend lines (which are algorithmically possible) and channels. Another is the 50% rule which asserts that each directional price move eventually will retrace 50% of that move. Another common support and resistance algorithm involves the use of Fibonacci series; primarily the 38.2, 50, and the 61.8 percent retrace levels. Again, almost universally, price is the only component.

Therefore, the need for a comprehensive set of algorithms that incorporate each of the three basic data types (time, price and volume) is needed. This includes the derivative indicators based on the qualified trends, trend failure rate probabilities and anchored support and resistance zones.

### BRIEF SUMMARY

Some embodiments of the present invention determine trend transitions (beginning and ending) and price zones (areas) on a chart where price support or resistance are likely to exist. For both qualified trends and anchored support and resistance, all three basic data types (time, price and volume) are utilized as part of the computation.

Some embodiments described herein for the algorithmic construction of anchored support and resistance zones begins with the identification of anchor bars which are determine as a function of volume and price over time. High volume and wide price spread bars are identifiable over a defined time period (60 bars of data). Once discovered, anchor bars are utilized to construct anchor zones—price zones where overlapping and adjacent anchor bars indicate buying and selling pressure (support and resistance zones).

The computation of anchored support and resistance as well as qualified trend enables the construction of additional derivative indicators. One is the issuance of trading signals. All tradable instruments are examined for qualified trend across each time frame; for anchored support and resistance zones; and for the probability of failure based on the historical database of trend and trade failure probability data. Relative to the above inputs, numerous entry and exit computations are performed to identify potential trading signals.

Some embodiment present qualified trends through a visual snapshot called The Trading Cube. Anchored support and resistance zones are presented as sortable tables and trading signals are filtered based on time frames and user preferences.

Some embodiments provide trend determination and qualification through swing point identification and swing point breaks. Furthermore, the potential demise of a trend is calculable once qualified trends are identified and is updated on an ongoing basis reflective of the ever changing probabilities. An abstraction of time being represented as bars enables a universal applicability to any data source. Further, three time frames are introduced as equidistant relative to the number of bars they contain. Qualified trends may be displayed via a computer display presentation vehicle termed The Trading Cube. The Trading Cube may present, in a very compressed format, qualified trends across each of the three time frames. Where applicable (for stock market specific data), the Trading Cube may also presents the qualified trends for the applicable sector and general market across each of the time frames. The presentation is abstracted to be universally applicable for any three-tiered data set (in this case a stock, a stock sector, and a general market of stocks).

In all trading exchanges, there are price points where, for whatever reason, price encounters difficulty rising (resistance) or falling (support). Some embodiments of the present invention also describes a way to address support and resistance that incorporate time, price and volume in their calculation.

Finally, some embodiments of the invention utilizes the above derived data to pinpoint price points where trade entry and exit are potentially profitable and presents the price points along with the reasoning on a computer display.

The preceding Summary is intended to serve as a brief introduction to some embodiments of the invention. It is not meant to be an introduction or overview of all inventive subject matter disclosed in this document. The Detailed Description that follows and the Drawings (or “Figures” or “FIGs.”) that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matter is not to be limited by the illustrative details in the Summary, Detailed Description and the Drawings, but rather is to be defined by the appended claims, because the claimed subject matter may be embodied in other specific forms without departing from the spirit of the invention.

### BRIEF DESCRIPTION OF THE DRAWINGS

The novel features of the invention are set forth in the appended claims. However, for purpose of explanation, several embodiments of the invention are set forth in the following drawings.

FIG. 1 illustrates logical software modules/components of some embodiments that are implemented within a computer system;

FIG. 2 illustrates a process used by some embodiments for identifying swing point highs;

FIG. 3 illustrates a process used by some embodiments for identifying swing point lows;

FIG. 4 illustrates a flow chart for a conceptual process used by some embodiments for identifying swing point breaks for swing point lows;

FIG. 5 illustrates a flow chart for a conceptual process used by some embodiments for identifying swing point breaks for swing point highs;

FIG. 6 illustrates a process used by some embodiments for qualifying trends based on swing point low breaks;

FIG. 7 illustrates a process used by some embodiments for qualifying trends based on swing point high breaks;

FIG. 8 illustrates a process used by some embodiments for determining high volume anchor bars;

FIG. 9 illustrates a process used by some embodiments for locating anchor bars that are created due to wide price spread;

FIG. 10 illustrates a process used by some embodiments for determining clustered anchor bars;

FIG. 11 illustrates a process used by some embodiments for determining congruent anchor bars;

FIG. 12 illustrates a process used by some embodiments for determining anchor zones where price support or resistance is most probable to occur;

FIG. 13 illustrates a process used by some embodiments to track all qualified trend failures and continually update a trend failure probability rate matrix;

FIG. 14 provides a process to present qualified trends in a hierarchical relationship based on sectors and general markets;

FIG. 15 provides a process used by some embodiments for presenting the Trading Cube snapshot view of a symbol;

FIG. 16 provides a process used by some embodiments for presenting anchored support and resistance zones created by processes similar to those described FIGS. 8-12;

FIG. 17 provides a conceptual process used by some embodiments for presenting a scanner for qualified trends;

FIG. 18 illustrates a process used by some embodiments for determining potential trading signals based on information created by processes similar to those described in FIGS. 2-13 for one side range trades;

FIG. 19 illustrates a process used by some embodiments for determining potential trading signals based on information created in FIGS. 2-13 for two side range trades;

FIG. 20 illustrates a process used by some embodiments for determining potential trading signals based on information created in FIGS. 2-13 for fast retrace trades;

FIG. 21 illustrates a process used by some embodiments for determining potential trading signals based on information created in FIGS. 2-13 for slow retrace trades;

FIG. 22 illustrates a process used by some embodiments for determining potential trading signals based on information created in FIGS. 2-13 for breakout trades; and

FIG. 23 conceptually illustrates a schematic block diagram of a computer system with which some embodiments of the invention may be implemented.

### DETAILED DESCRIPTION

Numerous details, examples, and embodiments of the invention are set forth and described below. However, it will be clear and apparent to one skilled in the art that the invention is not limited to the embodiments set forth herein and that the invention may be practiced without some specific details discussed below.

Some embodiments of the present invention create and present trading information in novel ways to better arm a trader with information to make better decisions. Many trading concepts will be discussed in the detailed description which includes swing points, trend transitions, anchor bars and anchor zones. These concepts may be presented to an end user in various ways. For example, one presentation of data may gather the above trading concepts and display them all to a user as key neoclassical technical analysis events on a standard candlestick chart.

Swing points are utilized to determine trend and may be denoted as (L)ow and (H)igh markers on such a chart. When a swing point is surpassed on a closing basis, it causes a trend to transition. The transition can be a reaffirmation or a change to a new change. A reaffirmation occurs when trend transitions to the same trend. An example would be a suspect bullish trend transition to another suspect bullish or even a confirmed bullish trend. The latter case would create a stronger trend while the former would be of the same strength. Trend transitions may be denoted with arrows on one embodiment of a chart. For example, a red arrow may denote a suspect trend transitions while a green one denotes a confirmed trend transition. Trends can be either bullish (up arrow), bearish (down arrow) or sideways (sideways arrow) and may always be characterized as red or green to denote the suspect or bullish qualification.

Supply and demand may be evident on such charts in the form of anchor bars and zones. Anchor zones may be created via the combination of anchor bars. Anchor bars are the result of an algorithmic formula that examine the characteristics of each bar with respect to volume, wide price spread, and swing points. Each anchor bar may be ranked in importance and combined with other anchor bars to create zones. In some embodiments, anchor bars may be denoted as blue bars while all other bars are black or red.

In one embodiment, the chart may be constructed via candlesticks and each bar may be colored based on the following exemplary formula: red body if the close on the bar is lower than the close on the prior bar (unless an anchor bar), black outline and white body if the close on the bar is higher than the close on the prior bar (unless and anchor bar), blue body if the close on the bar is lower than the close on the prior bar and the bar is an anchor bar, and blue outline and white body if the close on the bar is higher than the close on the prior bar is an anchor bar. One of ordinary skill in the art would understand that other methods for designating bars may be utilized to achieve the same presentation without departing from the spirit of the invention.

The concept of anchor zones is used to determine a price area where supply and demand are evident and may be desirable for timing entry and exit. Some embodiments of a chart according to the present invention may do this by combining anchor bars (overlap and congruency) to create anchor zones. Anchor zones may either be above the current price, below it, or within it. Anchored support zones may be colored a soft green and may be either equal to or below the current closing price in some embodiments. Anchored resistance zones may be colored a soft red and may be above the current closing price in some embodiments.

The following will describe in more detail the concepts discussed above and several processes for determining swing points, trend transitions, anchor bars and anchor zones and various methods for presenting this information in a useful manner to end users.

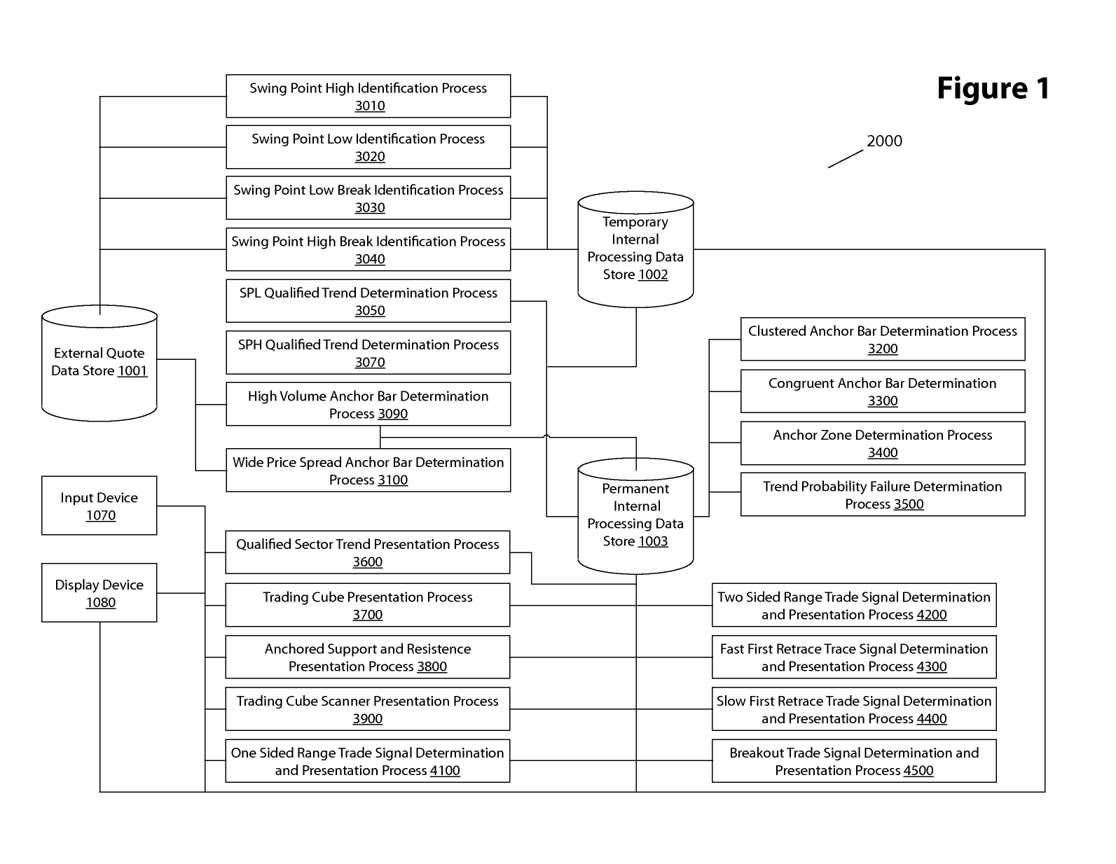

FIG. 1 illustrates the various logical components and modules of some embodiment that are implemented within a computer system. The modules consist of two primary types, modules that take raw data and create information and modules that present that information in unique ways for analysis by users. The definition and identification of trend is dependent on raw data 1001 representative of price movement. Each row of price data 1001 contains the instrument for which the price and volume data apply; a timestamp; an opening, high, low and closing price; and volume. Each of these data elements is required for each row.

Some embodiments of the present invention incorporate time as an integral in addition to volume and price. Time is abstracted to “bars”. A bar is defined as one row of price data. It may be assumed that each row of price data represents time equally independent of what the measurement is. It doesn't matter if each bar is 1 minute, 1 day, 1 month or any other interval. All bars may be treated equally as part of a time frame. Time frames encompass 60 bars. 60 bars of daily data equates to roughly 3 months of bars. 60 bars of weekly data equates to a little over one year of weekly data. This abstraction is critical to the incorporation of time into the algorithms.

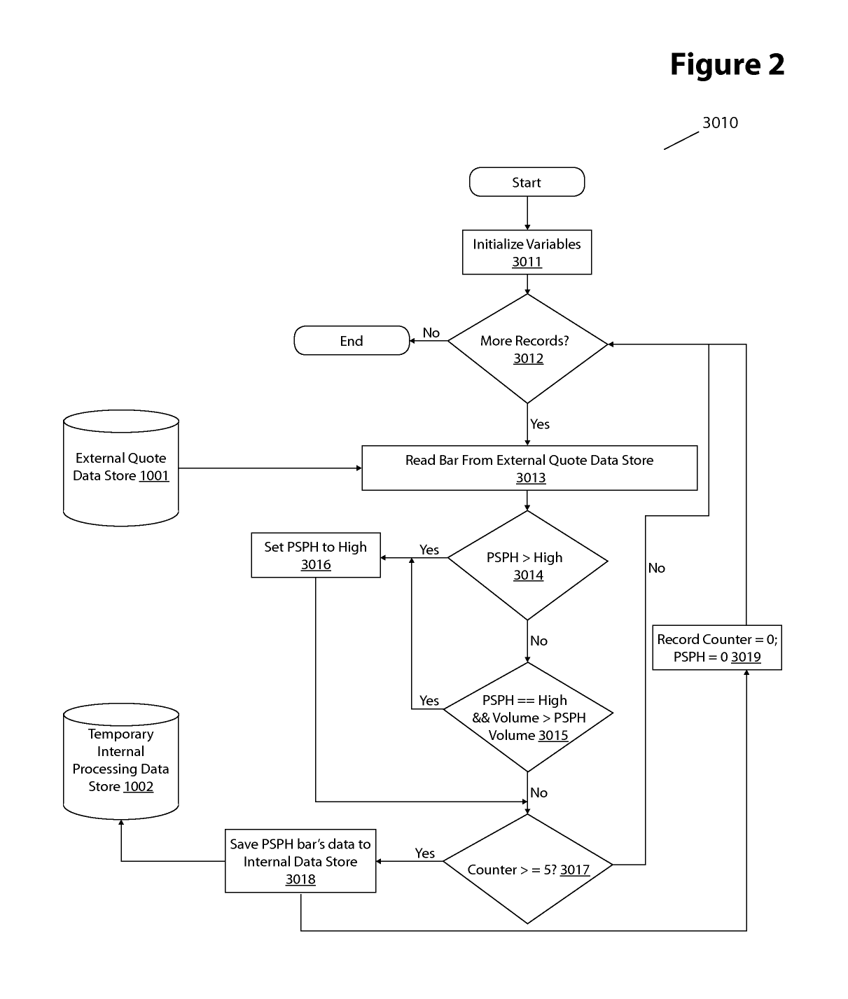

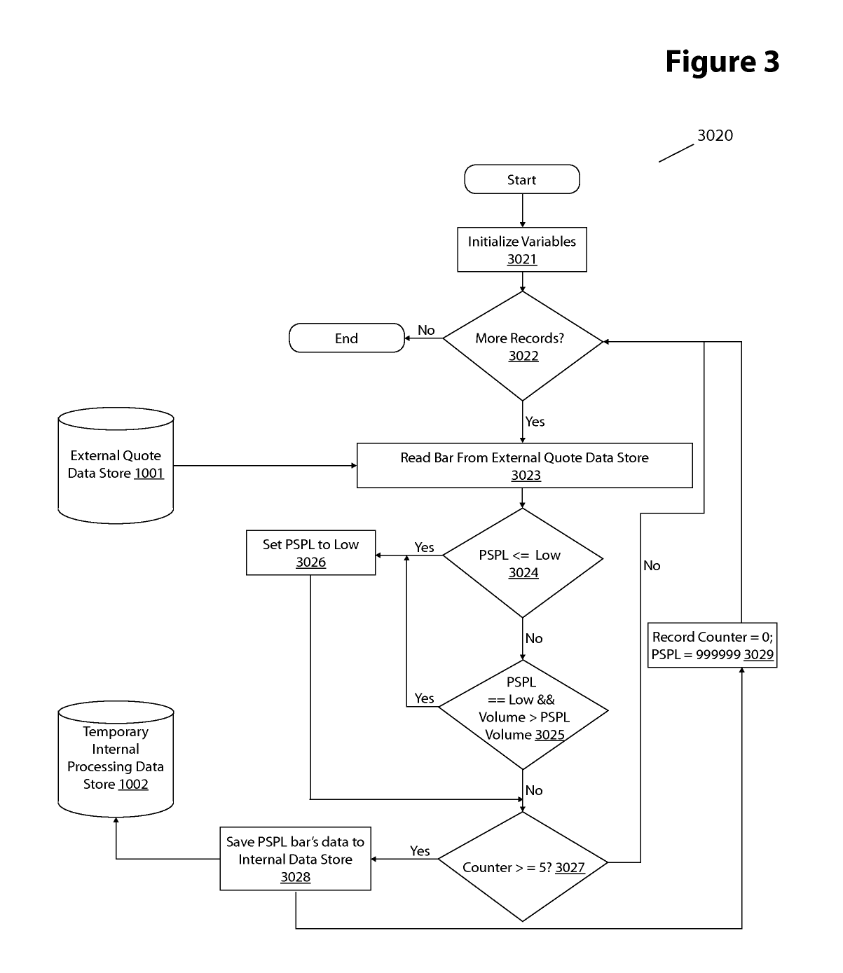

FIG. 2 and FIG. 3 illustrate a swing point identification process used by some embodiments. Swing points are identified systematically and algorithmically as described in processes 3010 and 3020. Swing point highs and lows are the markers enabling upward/bullish and downward/bearish trend determination and qualification. The trend determinations may yield significant current as well as additional future derived information possibilities.

As illustrated in FIG. 2, the swing point high identification process 3010 begins with the initialization of variables 3011 to track the number of bars examined and to track the value of the potential swing point high (PSPH) bar. The PSPH is initialized to 0 (zero) to guarantee that the first comparison results in a higher high as compared to the PSPH. An iterative loop begins with the limit of the loop being the 60 bars of data or the existence of more records to read 3012 from the external quote data store 1001.

A record/bar is read 3013 from the external quote data store 1001. The high of the record/bar read is compared to the internal variable containing the PSPH. If the bar's high is greater than the PSPH 3014 or if the bar's high is equal to the PSPH and the volume on the bar is greater than the volume of the PSPH 3015, then the PSPH is replaced with the high from the bar 3016.

If the record counter >=5 3017 then the PSPH becomes actualized 3018. Actualization implies that all the data associated with the bar is saved to the temporary internal processing data store 1002. The record counter is initialized to 0 (zero) and the PSPH is initialized to 0 (zero) to guarantee that the first comparison results in a higher high 3019.

In a similar way, as illustrated in FIG. 3, swing point lows are identified systematically and algorithmically. The swing point high identification process 3020 begins with the initialization of variables 3021 to track the number of bars examined and to track the value of the potential swing point low (PSPL) bar. The PSPL is initialized to 999999 to guarantee that the first comparison results in a lower low as compared to the PSPL. An iterative loop begins with the limit of the loop being the 60 bars of data or the existence of more records to read 3022 from the external quote data store 1001. A record/bar is read 3023 from the external quote data store 1001.

The low of the record/bar read is compared to the internal variable containing the PSPL. If the bar's low is less than the PSPL 3024 or if the bar's low is equal to the PSPL and the volume on the bar is greater than the volume of the PSPL 3025, then the PSPL is replaced with the low from the bar 3026.

If the record counter >=5 3027 then the PSPL becomes actualized 3028. Actualization implies that all the data associated with the bar is saved to the temporary internal processing data store 1002. The record counter is initialized to 0 (zero) and the PSPL is initialized to 999999 to guarantee that the first comparison results in a lower low 3029.

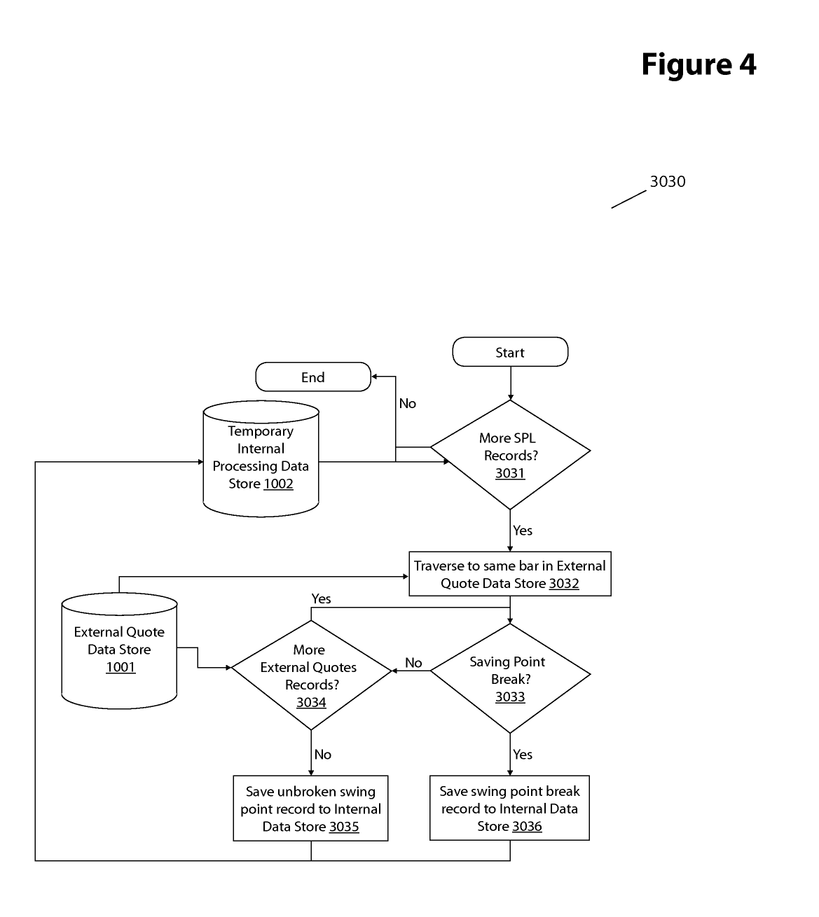

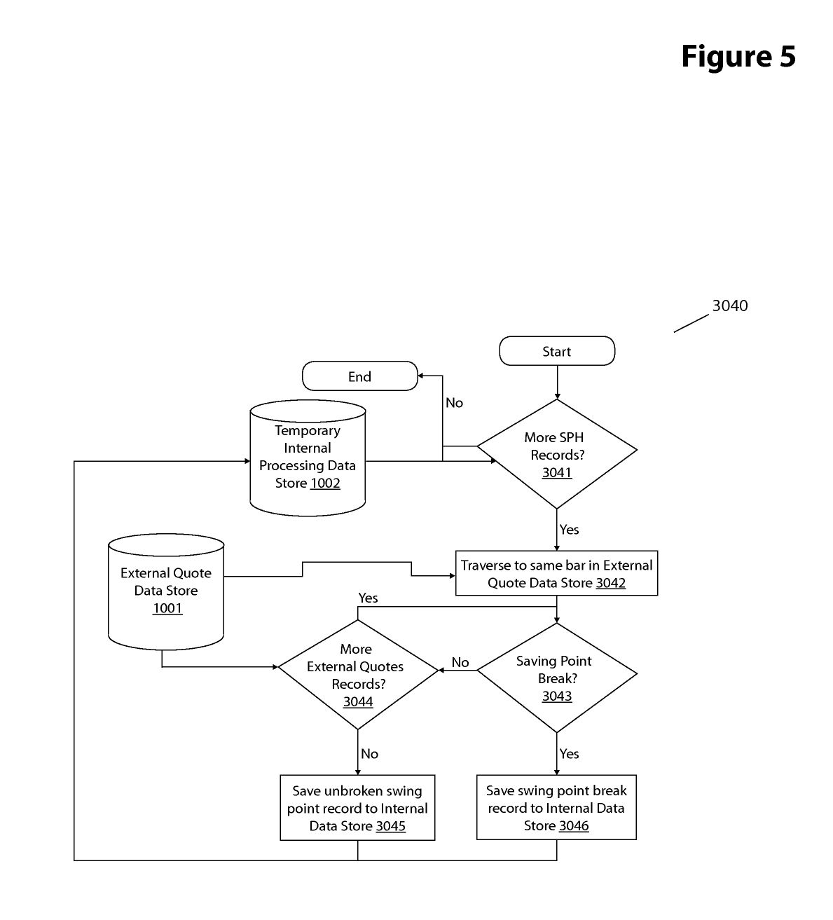

Swing points, once identified, can be examined for breakage as seen in the conceptual processes 3030 and 3040 in FIG. 4 and FIG. 5. A swing point break occurs when price data indicates that the extreme price point associated with the swing point is overcame by the closing price on a bar that appears later in time. For a swing point high to break, a subsequent bar would need to have a closing high that is greater than the high of the swing point bar. For a swing point low to be broken, a subsequent bar would need to have a closing low that is lower than the low of the swing point bar.

As part of this identification process, a permanent data store is updated to support another concept of trend failure probability rates. Each time a swing point break takes place a trend transitions. If a trend is considered as having a life cycle, then the duration (life cycle) for each trend can be stored and later used to construct failure rate probability matrixes.

As illustrated in FIG. 4, the swing point low break identification process 3030 begins by entering an iterative loop. As long as there is more swing point low records previously determined in process 3020 and stored into the temporary internal processing data store 1002 then each is read in sequence and processed 3031.

Once read, the external quote data store is accessed 1001 and traversed in order to arrive at the same bar as the swing point low bar 3032. Then a determination 3033 of whether the low of the bar read from the external quote data store 1001 is lower than the swing point bar. If so, then this is a swing point break and it is saved 3036 to the internal data store 1002 along with all the detailed data from both the swing point low bar and the swing point break bar.

If the low of the bar read from the external quote data store 1001 is not lower than the swing point bar, then another bar is read 3034, if available, from external quote data store 1001 and the above step are repeated.

If no more records exist in the external quote data store 1001 for this symbol, then this is an unbroken swing point record. So the unbroken swing point record is saved 3035 to the temporary internal processing data store 1002 and the process 3030 proceeds to the next swing point record.

As illustrated in FIG. 5, the swing point high break identification process 3040 begins by entering an iterative loop where as long as there are more swing point high records previously determined in process 3010 and stored into the temporary internal processing data store 1002 then each is read in sequence and processed 3041.

Once read, the external quote data store is accessed 1001 and traversed in order to arrive at the same bar as the swing point high bar 3042. Then a determination 3043 whether the high of the bar read from the external quote data store 1001 is higher than the swing point bar 3043. If so, then this is a swing point break and it is saved 3046 to the internal data store 1002 along with all the detailed data from both the swing point high bar and the swing point break bar.

If the high of the bar read from the external quote data store 1001 is not higher than the swing point bar, then another bar is read 3044, if available, from external quote data store 1001 and the above step are repeated.

If no more records exist in the external quote data store 1001 for this symbol, then this is an unbroken swing point record. So the unbroken swing point record is saved 3045 to the temporary internal processing data store 1002 and the process 3040 proceeds to the next swing point record.

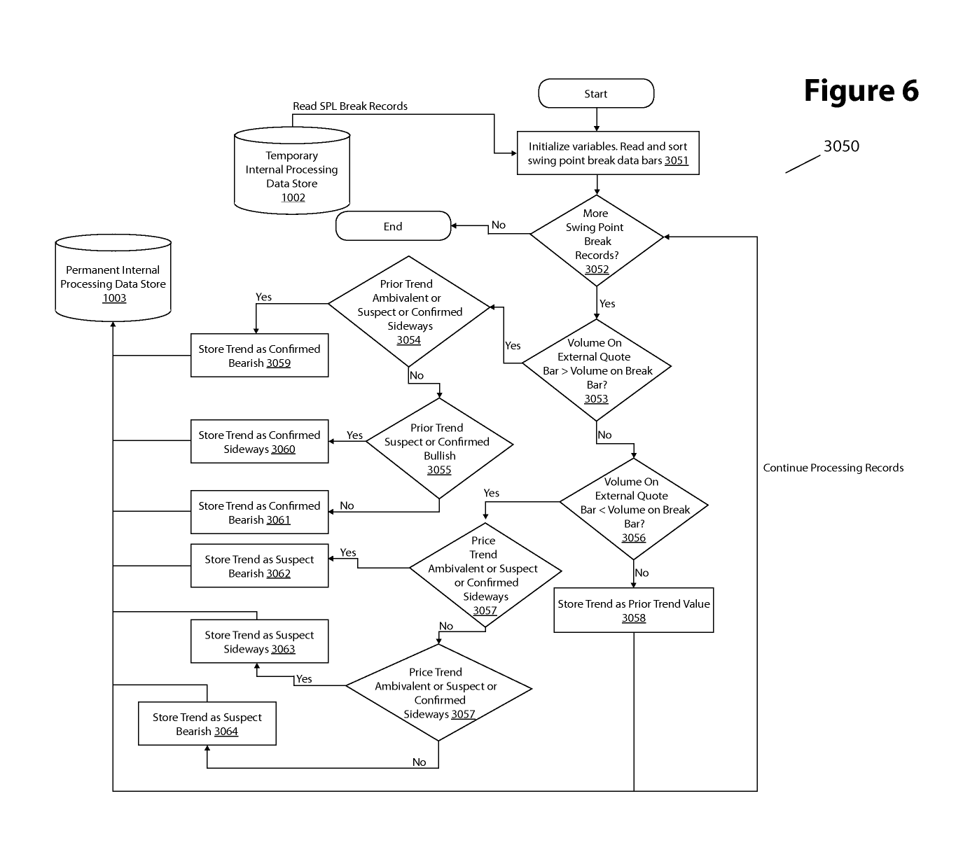

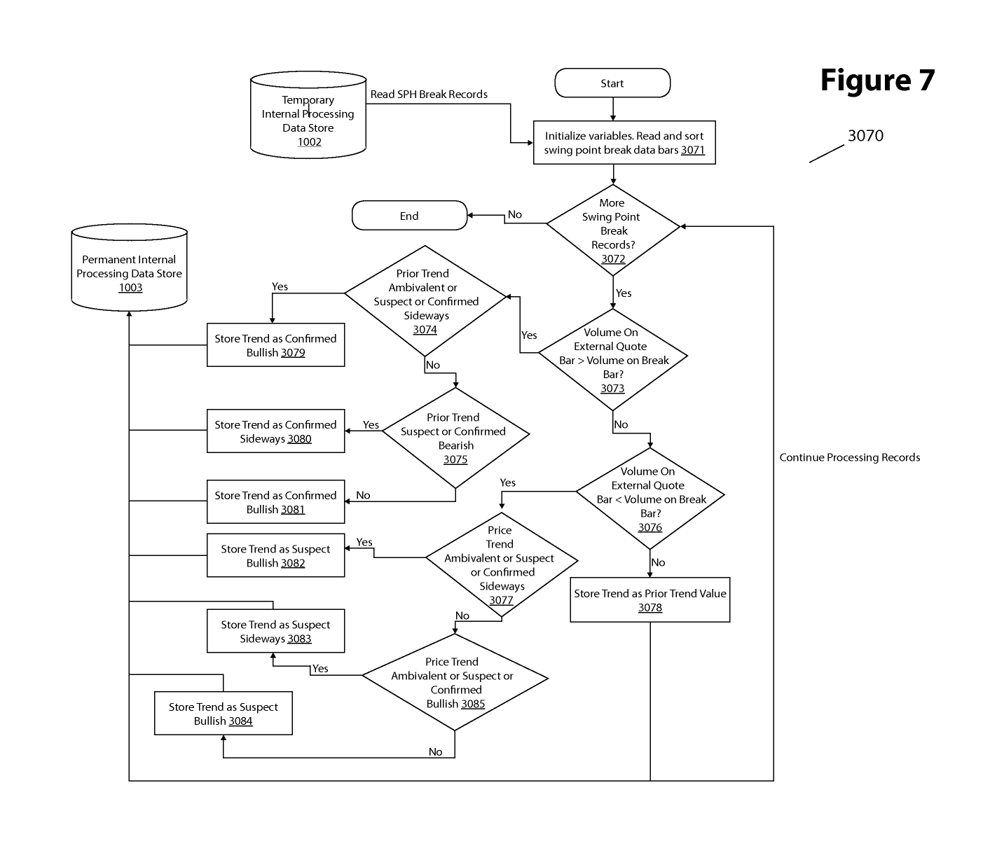

Once swing points are identified along with all swing point breaks, a trend can be algorithmically assigned and qualified as seen in the conceptual processes 3050 and 3070 in FIG. 6 and FIG. 7. Trend qualification is the assignment of a qualifier to trend once determined. The trend can either be “suspect” or “confirmed”. A suspect qualifier occurs when the volume associated with the bar doing the break is less than the volume of the swing point bar being broken. A confirmed qualifier occurs when the volume associated with the bar doing the break is greater than the volume of the swing point bar being broken. When a trend is displayed to the end user in some embodiments of the present invention, different color schemes may be used to display a suspect or confirmed trend. For example, labeling a trend in green may convey that the trend is confirmed, while labeling a trend red conveys that the trend is suspect.

FIG. 6 describes process 3050 which identifies qualified trends for swing point lows. The prior trend is initialized as “ambivalent” and the swing point low break bar data is read in from the temporary internal processing data store 1002 and sorted by break data.

An iterative loop 3052 begins which continues until there are no more swing point low break records to process. The process 3050 examines the swing point break bar data by comparing 3053 the broken swing point bar's volume with the bar's volume that broke it.

If the volume of the breaking bar is greater than the swing point bar that was broken 3053, then the prior trend is checked. If the prior trend is “ambivalent” or “suspect sideways” or “confirmed sideways” 3054, then the trend is assigned as “confirmed bearish” 3059 and stored in the permanent internal processing data store 1003. If the prior trend was “suspect bullish” or “confirmed bullish” 3055 then the trend is assigned as “confirmed sideways” 3060 and stored in the permanent internal processing data store 1003 otherwise the trend is assigned as “confirmed bearish” 3061 and stored in the permanent internal processing data store 1003.

If the volume of the breaking bar is less than the swing point bar that was broken, then the prior trend is checked. If the prior trend is “ambivalent” or “suspect sideways” or “confirmed sideways” 3057, then the trend is assigned as “suspect bearish” 3062 and stored in the permanent internal processing data store 1003. If the prior trend was “suspect bullish” or “confirmed bullish” 3065 then the trend is assigned as “suspect sideways” 3063 and stored in the permanent internal processing data store 1003 otherwise assign the trend is assigned as “suspect bearish” 3064 and stored in the permanent internal processing data store 1003.

If the volume of the breaking bar is equal to the swing point bar that was broken, then the trend is assigned as equal to prior trend 3058.

FIG. 7 describes process 3070 which identifies qualified trends for swing point highs. The prior trend is initialized as “ambivalent” and the swing point high break bar data is read in from the temporary internal processing data store 1002 and sorted by break data.

An iterative loop 3072 begins which continues until there are no more swing point high break records to process. The process 3070 examines the swing point break bar data by comparing 3073 the broken swing point bar's volume with the bar's volume that broke it.

If the volume of the breaking bar is greater than the swing point bar that was broken 3073, the prior trend is checked. If the prior trend is “ambivalent” or “suspect sideways” or “confirmed sideways” 3074, then the trend is assigned as “confirmed bullish” 3079 and stored in the permanent internal processing data store 1003. If the prior trend was “suspect bearish” or “confirmed bearish” 3075 then the trend is assigned as “confirmed sideways” 3080 and stored in the permanent internal processing data store 1003 otherwise the trend is assigned as “confirmed bullish” 3081 and stored in the permanent internal processing data store 1003.

If the volume of the breaking bar is less than the swing point bar that was broken, then the prior trend is checked. If the prior trend is “ambivalent” or “suspect sideways” or “confirmed sideways” 3077, then the trend is assigned as “suspect bullish” 3082 and stored in the permanent internal processing data store 1003. If the prior trend was “suspect bullish” or “confirmed bullish” 3085 then the trend is assigned as “suspect sideways” 3083 and stored in the permanent internal processing data store 1003 otherwise the trend is assigned as “suspect bullish” 3084 and stored in the permanent internal processing data store 1003.

If the volume of the breaking bar is equal to the swing point bar that was broken, then the trend is assigned as equal to prior trend 3078.

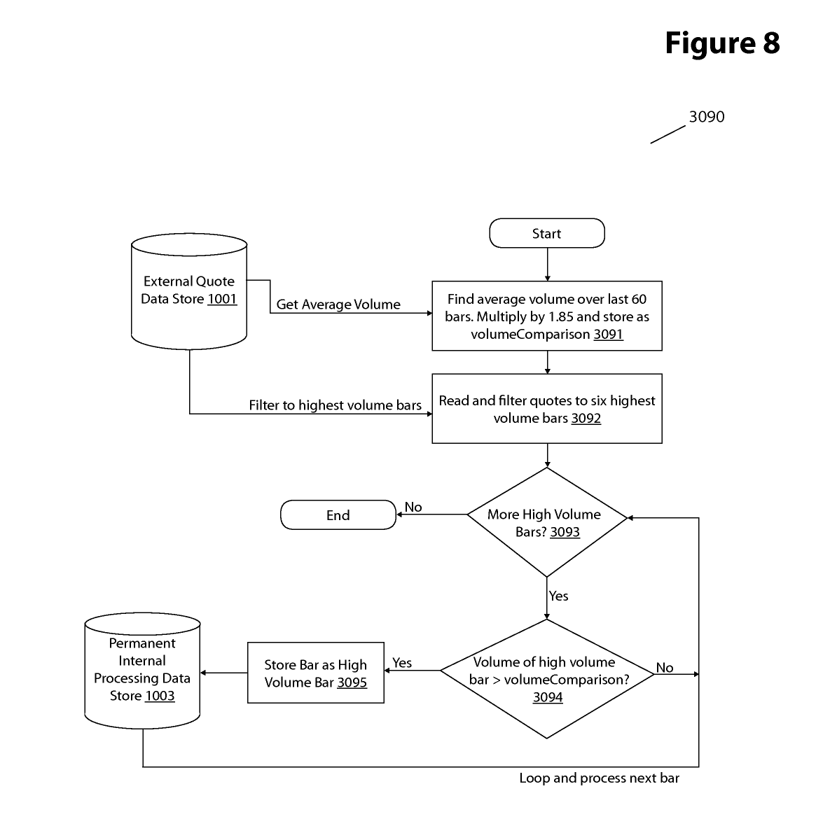

FIG. 8 describes process 3090 which is somewhat removed from the processes described above in FIG. 2-FIG. 7 and are not necessarily tied to swing points. FIG. 8 provides the concept of anchor bars which has as its central goal, the idea that supply and demand can be measured and identified as critical price points over time. One such measurement is the identification of high volume anchor bars.

As illustrated in FIG. 8, the process 3090 begins by determining 3091 the average volume for all bars over the past 60 bars and multiplying that by a factor of 1.85 to establish a benchmark high volume level for comparison. Then, each of the last 60 bars are sorted and filtered 3092 to include only the six highest volume bars.

If a determination 3093 that no high volume price spread bars exist is made then the process 3090 is complete, otherwise the process 3090 compares 3094 the high volume anchor bars to the benchmark high volume level.

If the high volume bar currently under examination has higher volume than the benchmark wide price spread, then the bar is stored 3095 as a high volume bar in the permanent internal processing data store 1003. If not, the process 3090 continues to the remaining bars 3093.

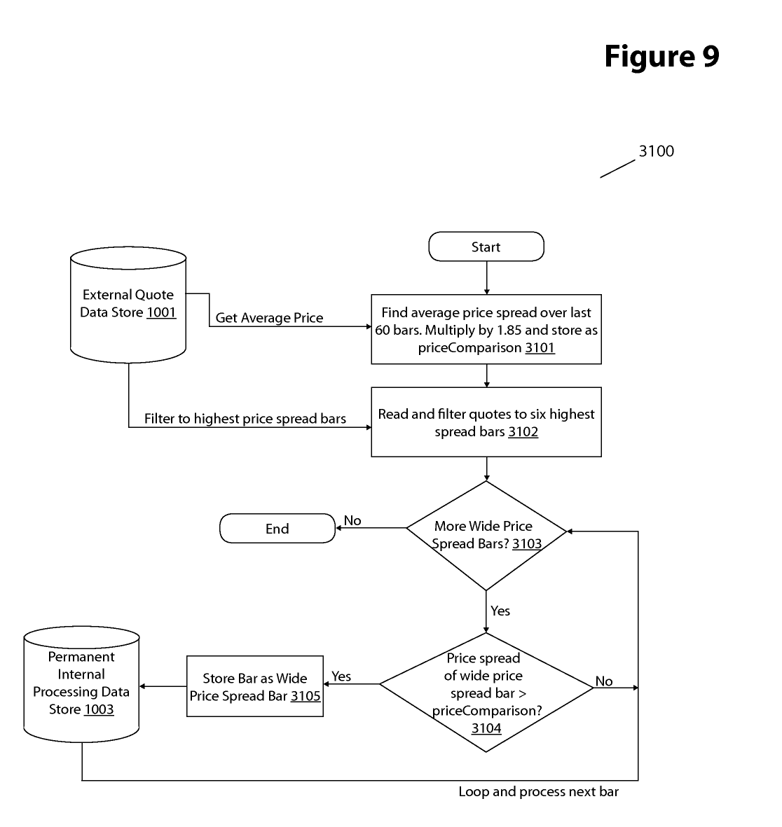

FIG. 9 describes a process 3100 that continues the identification of supply and demand price points with a different kind of anchor bar, namely a wide price spread anchor bar.

A shown in FIG. 9, the process 3100 begins by determining 3101 the average price spread for all bars over the past 60 bars and multiply that by a factor of 1.85 to establish a benchmark high wide price spread level for comparison. Each of the last 60 bars are sorted and filtered 3102 to include only the six highest wide price spread bars.

If a determination 3103 that no more wide price spread bars exist is made then the process 3100 is complete, otherwise the process 3100 compares 3104 the wide price spread anchor bars to the benchmark wide price spread level.

If the wide price spread bar currently under examination has a wider price spread than the benchmark wide price spread, then the bar is stored 3105 as a wide price spread bar in the permanent internal processing data store 1003. If not, the process 31000 continues to the remaining bars 3103.

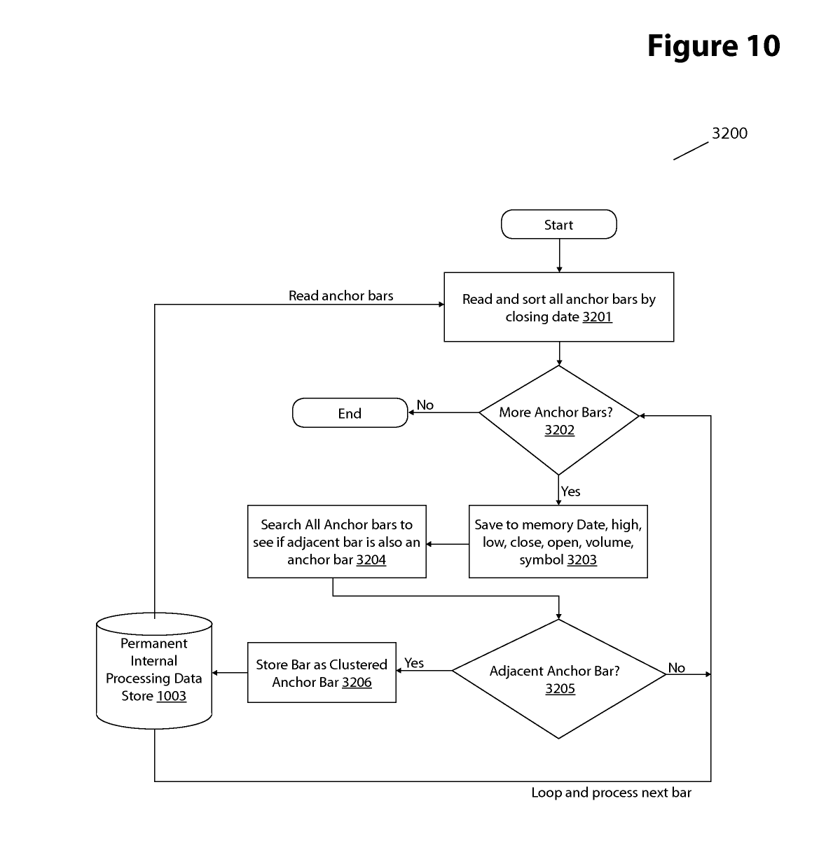

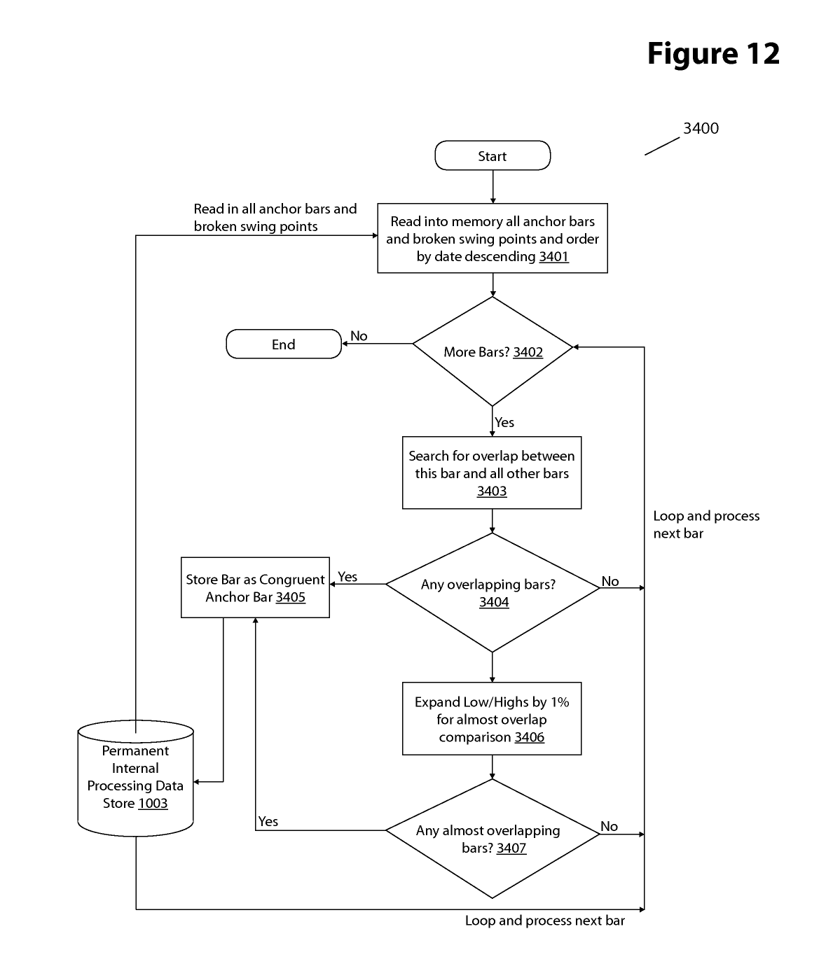

FIG. 10 describes process 3200 which takes the output anchor bars from processes 3090 and 3100 of FIG. 8 and FIG. 9 and combines those anchor bars together as clustered anchor bars which can then later be used to create anchor zones as described later in reference to FIG. 12.

As illustrated in FIG. 10, the process begins by the reading 3201 into memory and sorting all previously determined anchor bars by the closing date. A determination 3202 of whether no more anchor bars exist is made. If so, then the process 3200 is complete, otherwise the date, high, low, close, open, volume and symbol is saved 3203 into an internal variable. Then, all anchor bars are searched 3204 to see if there is another anchor bar that is adjacent to the current anchor bar.

If it is determined 3205 that an adjacent anchor bar is present, then it is stored 3206 as a clustered anchor bar into the permanent internal processing data store 1003. If not, then process 3200 proceeds to the next anchor bar 3202.

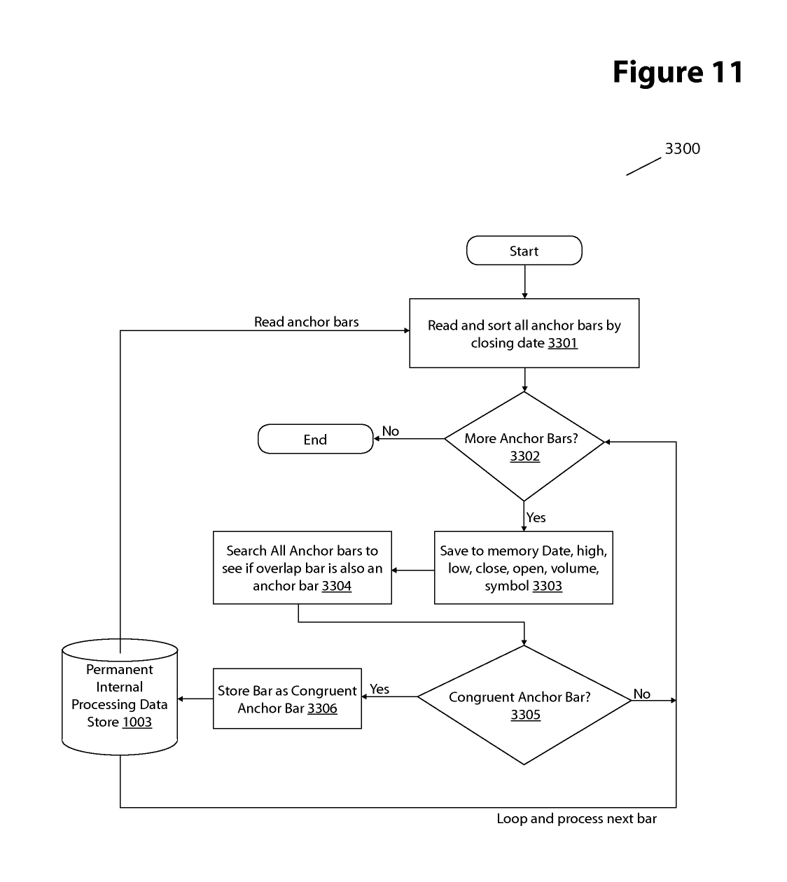

FIG. 11 describes process 3300 which takes the output anchor bars from processes 3090 and 3100 of FIG. 8 and FIG. 9 and combines those anchor bars together as congruent anchor bars. Congruent anchor bars are bars that are not adjacent but whose price boundaries are congruent with other anchor bars having similar price boundary price points. Congruent anchor bars may eventually be used to create anchor zones as described below in reference to FIG. 12.

As illustrated in FIG. 11, the process 3300 begins by the reading 3301 into memory and sorting all previously determined anchor bars by the closing date. A determination 3302 of whether no more anchor bars exist is made. If so, then the process 3300 is complete, otherwise the date, high, low, close, open, volume and symbol is saved 3303 into an internal variable. Then, all anchor bars are searched 3304 to see if there is another anchor bar that overlaps (the high and low) with the current anchor bar.

If it is determined 3305 that there is a congruent anchor bar, then it is stored 3306 as a congruent anchor bar into the permanent internal processing data store 1003. If not, then process 3300 proceeds to the next anchor bar 3302.

FIG. 12 describes process 3400 which takes the output from processes 3090, 3100, 3200 and 3300 along with broken swing points to create anchor zones. Anchor zones are the identification of price areas where support and resistance are most likely to be felt in future price action.

The process 3400 starts by reading (at 3401) all anchor bars and broken swing points into memory and sorting them in descending order from the permanent internal processing data store 1003. If no more anchor bars exist (at 3402) then the process 3400 is complete, otherwise a search for any overlap between the current bar and the next bar is performed (at 3403).

If an overlap is identified (at 3404), then the overlapping bars are stored (at 3405) into the permanent internal processing data store 1003 as congruent anchor bars. The process 3400 then continues processing additional anchor bars.

If an overlap is not identified (at 3404), then the lows and highs are expanded (at 3406) by 1% for further comparison. If the bars now are found (at 3407) to overlap, then the overlapping bars are stored (at 3405) into the permanent internal processing data store 1003. The process 3400 then continues processing additional anchor bars.

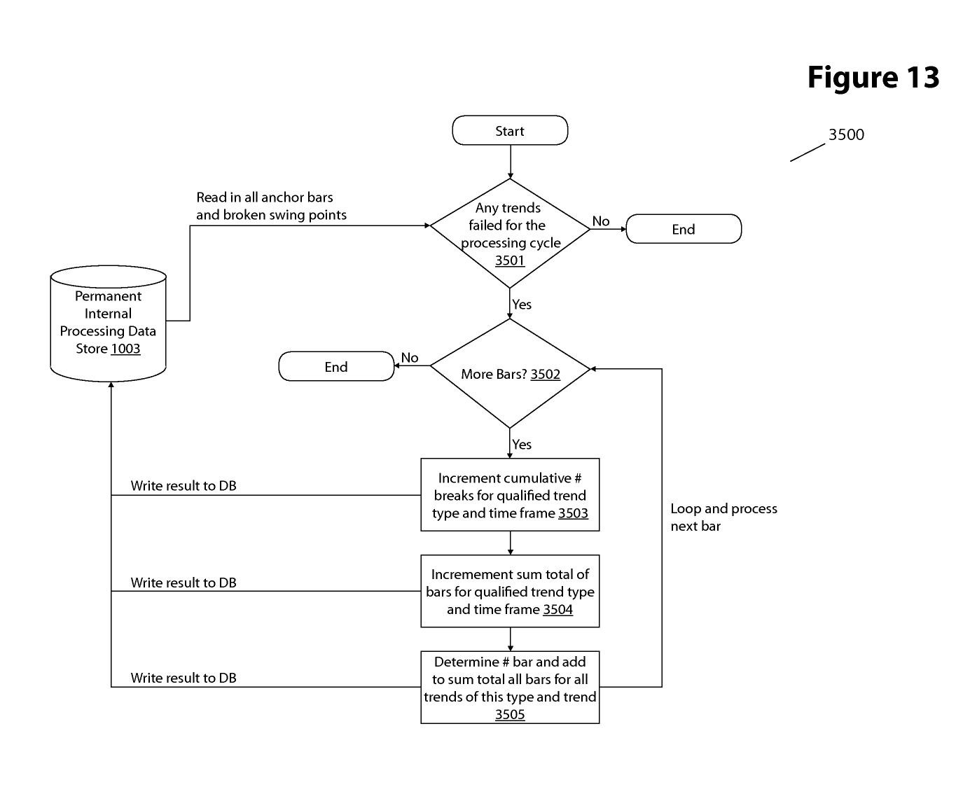

FIG. 13 describes process 3500 which continually updates trend failure rate probability tables each time a trend fails. This process treats a trend as having a life cycle just as a microwave or any other kitchen appliance. A microwave is known to have a life cycle of 10 years for example. Trends are no different and they too have a life cycle. It comes into existence, persists and eventually transpires. With the ability to qualify trends for all instruments, the capability of determining the mean-time-to-failure of each instrument is also available. A trend's meant time to failure (MTTF) captures the cumulative probability of a trends failure rate bar-by-bar and the important concept of time into the trading equation along with price and volume. Trend MTTF is the ability to forecast a trends demise and relative youth which may add a serious trading advantage to those that use it.

As illustrated in FIG. 13, the process begins (at 3501) by searching the permanent internal data store 1003 for any swing point breaks that have occurred on this processing cycle. If none are found the process is complete, otherwise each trend break that occurred is processed (at 3502).

If a swing point break occurred, the existing number of swing point breaks that have occurred for this qualified trend type and time frame are taken and increment by one (at 3503). Next, the number of bars for this trend that transitioned is determined (at 3504) and added that to the sum total of bars for all trends for this qualified trend type and time frame which is then updated to the permanent internal data store 1003. This is done for all trends that transitioned for this processing cycle.

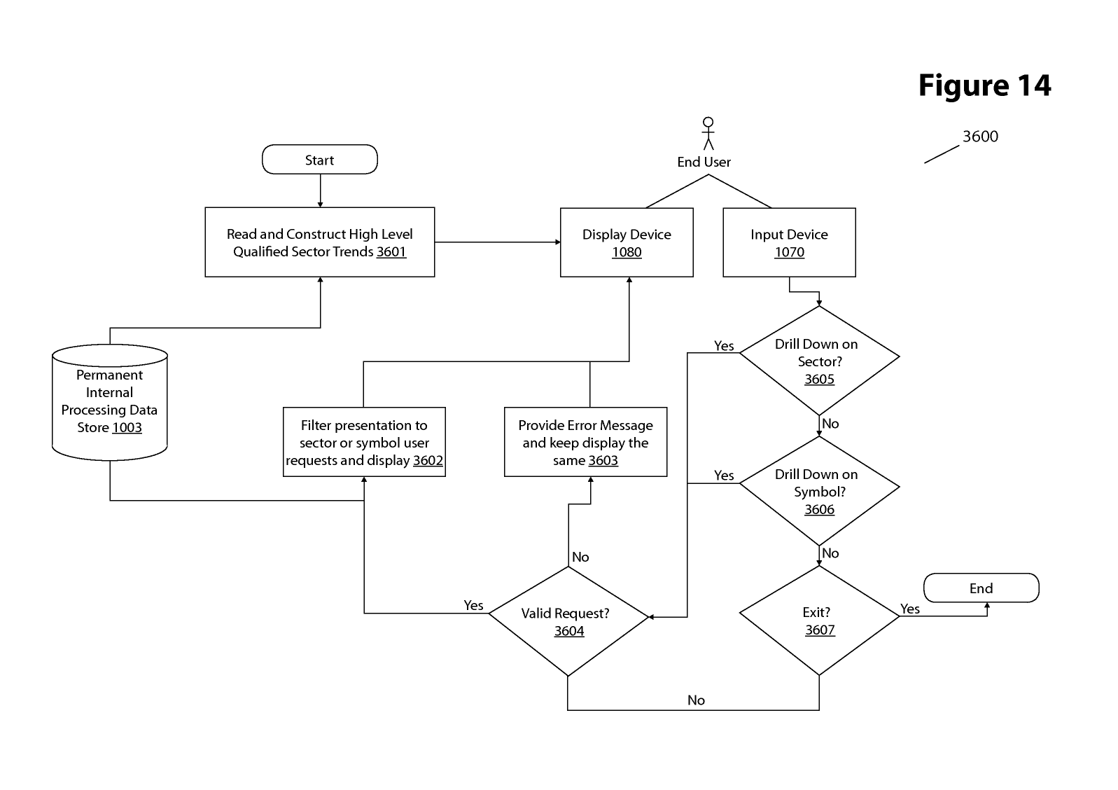

All prior processes described above were concerned with the creation of new and novel information from basic data sources. FIG. 14-FIG. 19 will now be discussed to illustrate new and novel ways to present the information created in the prior process/figures. FIG. 14 provides an algorithmic conceptual process to present qualified trends in a hierarchical relationship based on sectors and general markets. The presentation style allows a user to be in control of finding company symbols that share the same product mix by entering a particular sector and having all symbols that match that sector displayed or, conversely, by allowing a user to enter a specific symbol and find all other symbols matching that sector displayed. In all cases, the qualified trend across all three time frames (short, intermediate and long term) is available for inspection and sorting.

The process 3600 begins by reading (at 3601) qualified trends for the general markets and highest level sectors from the permanent internal processing data store 1003 and presenting that data to the end user via a display device 1080. The end user can choose to enter a symbol (at 3606) or to drill down on a high level sector (at 3605) to reveal specific information related to the request, or the user can choose to exit the application (at 3607) via data entry using the input device 1070.

If anything besides an exit command is received, then the request is validated (at 3604). If the request is not validated (at 3604), an error message is displayed (at 3603) via the display device 1080 to the end user.

If the request is valid (at 3604), the presentation data from the permanent internal processing data store 1003 is filtered (at 3602) to the requested sector or symbol and displayed via the display device 1080 to the end user. The process 3600 continues until the end user exits.

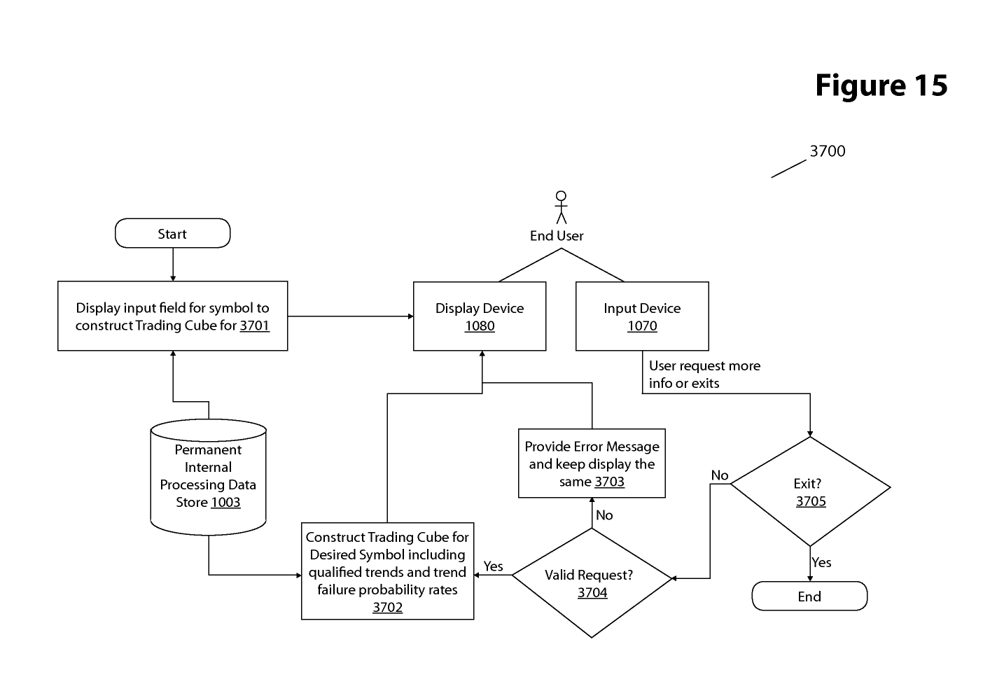

FIG. 15 provides a unique and novel concept termed The Trading Cube. The Trading Cube is a snapshot view of a symbol that is presented as cubes with the symbol's qualified trend displayed for all three time frames (short—about three months, intermediate—about nine months, and long term—about three years). The same is displayed for the sector that the symbol belongs to as well as the general market that the symbol is part of. Additionally, the trend failure probability rates are displayed for each of the qualified trends which provides a novel method for a user to measure the current potential for the trend's demise.

As shown in FIG. 15, the process 3700 begins with an empty Trading Cube presented to the user along with a means to enter a symbol (at 3701) to be examined via a display device 1080 to the end user.

The end user is able to enter (at 3701) a symbol via an input device 1070 which is examined (at 3705) for a request to exit the application. If the request is to exit, the application terminates.

If the user enters data it is examined (at 3704) to see if the request is valid. If not valid, an error message is displayed (at 3703) via the display device 1080 to the end user. If the request is valid, the Trading Cube is constructed (at 3702) from the permanent internal processing data store 1003 for the desired symbol showing qualified trends and failure probability rates for each qualified trend for the desired symbol, its sector, and general market across all three time frames and displayed to the user via the display device 1080.

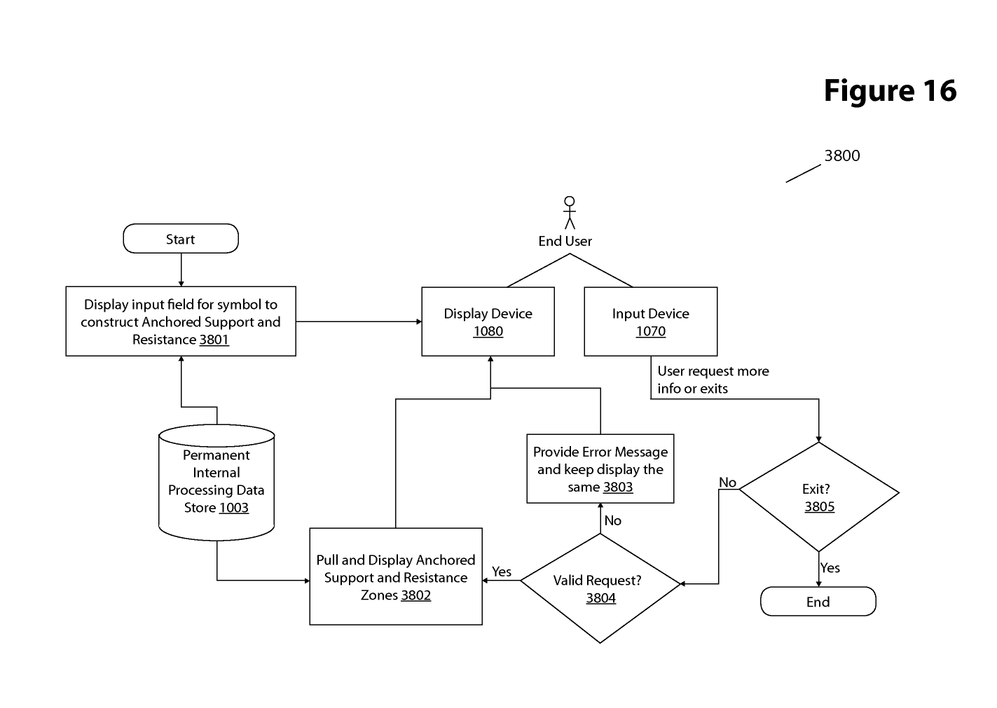

FIG. 16 describes the presentation process 3800 for displaying anchored support and resistance zones created previously as exhibited in FIG. 8-FIG. 12. Some embodiments of this presentation allows a user to visually understand (i) the qualified trend of the instrument being examined, (ii) the history of qualified trend transitions that has occurred for the instrument being examined, and (iii) anchored support and resistance bars and the zones created from them that are a reflection of where supply and demand should be felt for the instrument being examined

In one embodiment of the presentation process 3800, an input field is first displayed (at 3801) to the end user via a display device 1080. The end user can then either request to exit the application (at 3805) or to enter a symbol via the input device 1070. If no exit command is received (at 3805), then the symbol entered is checked for validity (at 3804). If the entered symbol is found as not valid, an error message is provided (at 3803) via the display device 1080 to the end user.

If a valid request is received (at 3804), then the anchored support and resistance zones for the desired symbol is accessed (at 3802) from the permanent internal processing data store 1003 and presented to the end user via the display device 1080. The process 3800 then continues until the end user exits the process.

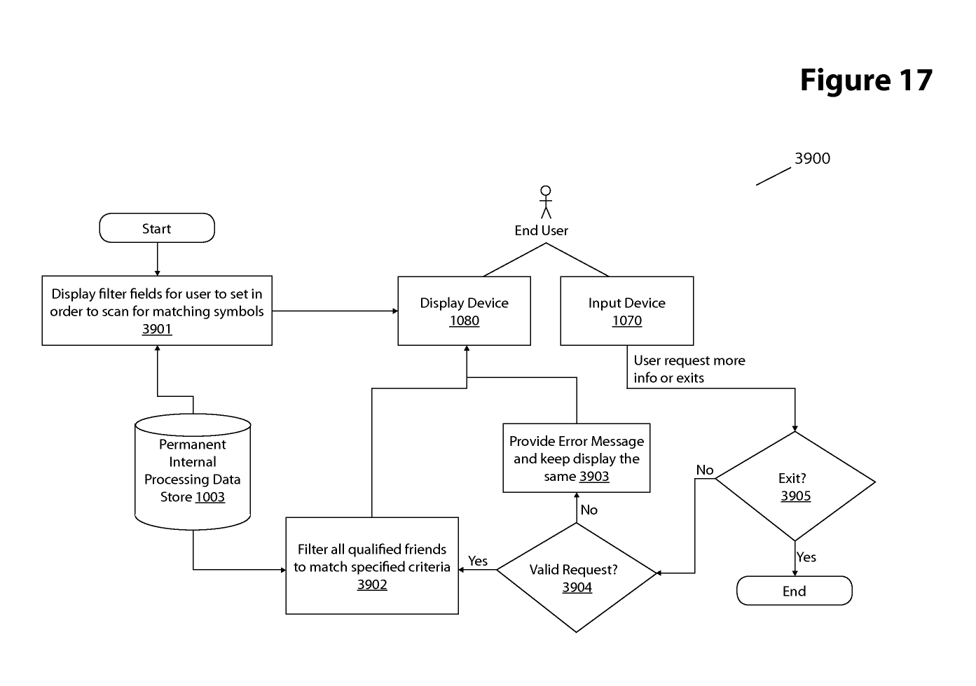

FIG. 17 introduces a conceptual process 3900 of a scanner for qualified trends. The process 3900 begins with an input screen being presented (at 3901) that shows the high level qualified trends for the general markets as accessed from the permanent internal processing data store 1003 and displayed via the display device 1080 to the end user.

The end user utilizes an input device 1070 to either request (at 3905) to exit in which case the application terminates, or to enter into values to scan for. Acceptable values may be accessed via pull down menus for each symbol, sector and general market for each time frame. The end user can specify a value for trend probability failure rates for each of the drop down entities that is used as a further filter at which point the request is validated (at 3904). If not valid, an error message displayed (at 3903) to the end user via the display device 1080.

If valid, all qualified trends for all symbols, sectors and general markets based on the entered trend probability failure rates are accessed (at 3902) from the permanent internal processing data store 1003 and presented to the end user via the display device 1080. The process 3900 continues until the end user exits the process.

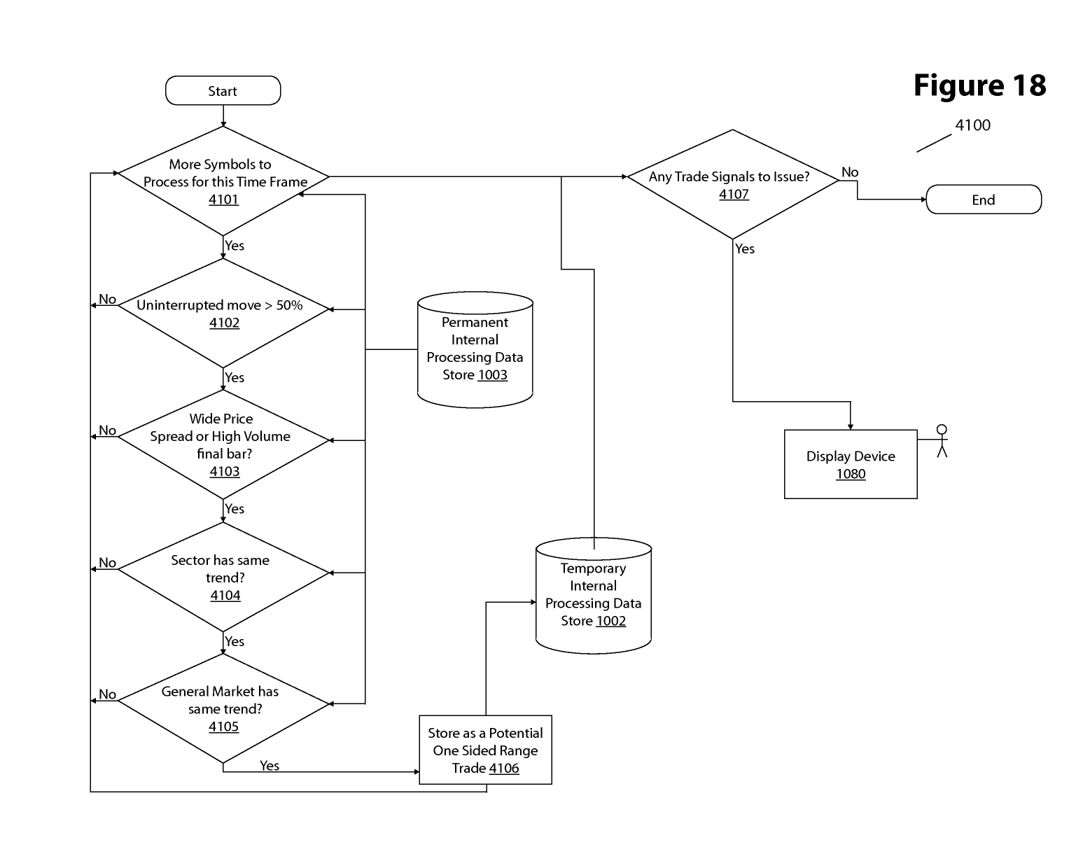

FIG. 18 describes, by way of conceptual process 4100, a novel method for algorithmically determining potential trading signals based on information created in FIG. 2-FIG. 13. FIG. 18 considers a decision tree for one side range trades and begins by entering into an iterative loop (at 4101) across all symbols in the permanent internal processing data store 1003 and examining each to see if they meet the trade setup criteria.

The first criterion is to access the permanent internal processing data store 1003 to determine (at 4102) if the symbol has experienced an uninterrupted increase (uptrend) or decrease (downtrend) in price that amounts to more than 50% without a trend transition on the time frame under examination. If not, the symbol is discarded and the iterative loop 4101 continues.

If so, then the next criterion is to access the data in the permanent internal processing data store 1003 to determine (at 4103) if the high (uptrend) or low (uptrend) of the uninterrupted move was demarcated by a wide price spread or high volume anchor bar. If not, the symbol is discarded and the iterative loop 4101 continues.

If so, then the next criterion is to access the data in the permanent internal processing data store 1003 to determine (at 4104) if the sector to which this symbol belongs has the same trend characteristics (uptrend or downtrend) as the symbol under examination. If not, the symbol is discarded and the iterative loop 4101 continues.

If so, then the final criterion is to access the data in the permanent internal processing data store 1003 to determine (at 4105) if the general market to which this symbol belongs has the same trend characteristics (uptrend or downtrend) as the symbol under examination. If not, the symbol is discarded and the iterative loop 4101 continues.

If so, then this is a potential one sided range trade setup, so the pertinent information regarding the potential trade is stored (at 4106) to the temporary internal processing data store 1002 and the iterative loop 4101 for all other symbols continues.

Once all symbols are processed, the temporary internal processing data store 1002 is accessed to determine (at 4107) if any potential one sided trading signals were generated. If so, the potential one sided range trade setups are displayed to the end user via the display device 1080 and the process 4100 exits. If no one sided trading signal were generated, the process 4100 just exits.

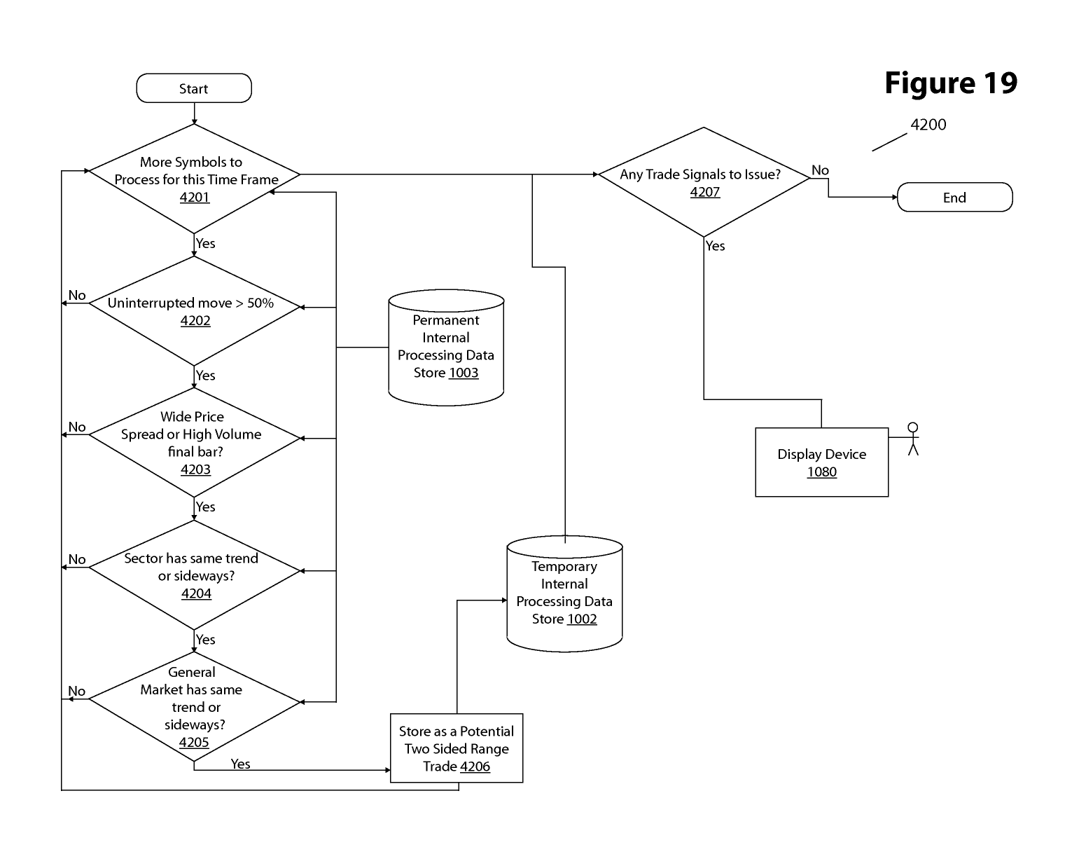

FIG. 19 describes, by way of conceptual process 4200, a novel method for algorithmically determining potential trading signals based on information created in FIG. 2-FIG. 13. FIG. 19 considers a decision tree for two side range trades and begins by entering into an iterative loop (at 4201) across all symbols in the permanent internal processing data store 1003 and examining each to see if they meet the trade setup criteria.

The first criterion is to access the permanent internal processing data store 1003 to determine (at 4202) if the symbol has experienced an uninterrupted increase (uptrend) or decrease (downtrend) in price that amounts to more than 50% without a trend transition on the time frame under examination. If not, the symbol is discarded and the iterative loop 4201 continues.

If so, then the next criterion is to access the data in the permanent internal processing data store 1003 to determine (at 4203) if the high (uptrend) or low (uptrend) of the uninterrupted move was demarcated by a wide price spread or high volume anchor bar 4203. If not, the symbol is discarded and the iterative loop 4201 continues.

If so, then the next criterion is to access the data in the permanent internal processing data store 1003 to determine (at 4204) if the sector to which this symbol belongs has the same trend characteristics (uptrend or downtrend) as the symbol under examination or if the trend for the sector is sideways. If not, the symbol is discarded and the iterative loop 4201 continues.

If so, then the final criterion is to access the data in the permanent internal processing data store 1003 to determine (at 4105) if the general market to which this symbol belongs has the same trend characteristics (uptrend or downtrend) as the symbol under examination or if the trend for the general market is sideways. If not, the symbol is discarded and the iterative loop 4201 continues.

If so, then this is a potential two sided range trade setup, so the pertinent information regarding the potential trade is stored (at 4206) to the temporary internal processing data store 1002 and the iterative loop 4201 for all other symbols continues.

Once all symbols are processed, the temporary internal processing data store 1002 is accessed to determine (at 4207) if any potential two sided trading signals were generated. If so, the potential two sided range trade setups are displayed to the end user via the display device 1080 and the process 4200 exits. If no two sided trading signal were generated, the process 4200 just exits.

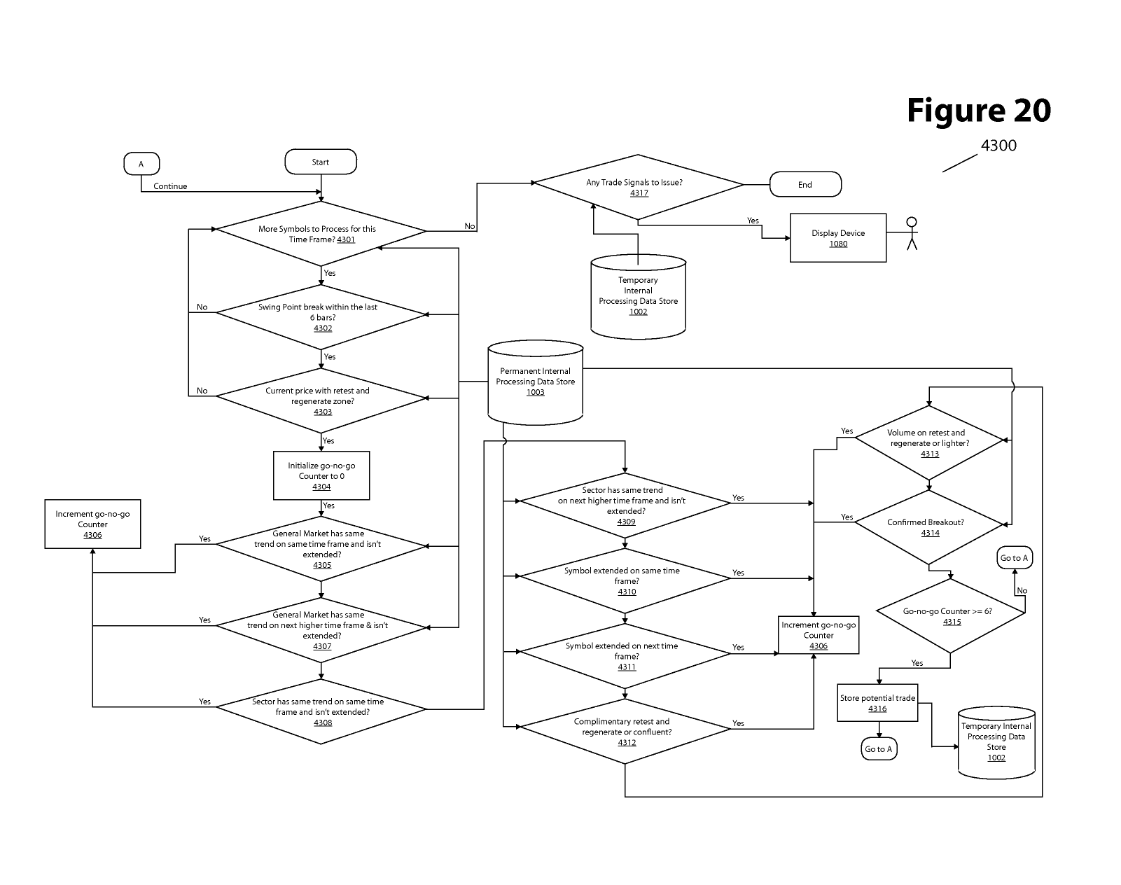

FIG. 20 describes, by way of conceptual process 4300, a novel method for algorithmically determining potential trading signals based on information created in FIG. 2-FIG. 13. FIG. 20 considers a decision tree for fast first retrace trades. A fast first retrace is a situation where a swing point break is followed by a retrace within six bars of the break. The trading signal is based on a number of criterions which, if enough are aligned, makes for a reasonably good probability that the trading signal has a higher probability of succeeding.

The process 4300 of FIG. 20 begins by entering into an iterative loop (at 4301) across all symbols in the permanent internal processing data store 1003 and examining each to see if they meet the trade setup criteria. The first criterion is to access the permanent internal processing data store 1003 to determine (at 4302) if the symbol has experienced a swing point break within the past six bars. If not, the symbol is discarded and the iterative loop 4301 continues.

If so, then the permanent internal processing data store 1003 is accessed to determine (at 4303) if the current price for the symbol is within the high (if a breakout in an uptrend) or the low (if a breakout in a downtrend). If not, the symbol is discarded and the iterative loop 4301 continues.

If the decision process reaches this point, the decision as to whether to issue a trading signal for this symbol is based on having six or more, preferably seven, of the next nine decision criterions being realized. Some embodiment may have more decision criterions and the issuance of a trading signal may be based on realizing about eighty percent of the decision criterions in such embodiments.

To start this determination, the process 4300 initializes (at 4304) a go-no-go counter in system memory 1040 that keeps track of how many decision criterion matches to zero. Next, the permanent internal processing data store 1003 is accessed to determine (at 4305) if the general market is aligned for the same time frame and trend failure probability rates is less than 50%. If so, then the go-no-go counter is incremented (at 4306).

Then the permanent internal processing data store 1003 is accessed to determine (at 4307) if the general market is aligned for the next higher time frame and trend failure probability rates is less than 50%. If so, then the go-no-go counter is incremented (at 4306).

Then the permanent internal processing data store 1003 is accessed to determine (at 4308) if the sector is aligned for the same time frame and trend failure probability rates is less than 50%. If so, then the go-no-go counter is incremented (at 4306).

Then the permanent internal processing data store 1003 is accessed to determine (at 4309) if the sector is aligned for the next higher time frame and trend failure probability rates is less than 50%. If so, then the go-no-go counter is incremented (at 4306).

Then the permanent internal processing data store 1003 is accessed to determine (at 4310) if the symbol being examined has trend failure probability rate of less than 50% for the current time frame. If so, then the go-no-go counter is incremented (at 4306).

Then the permanent internal processing data store 1003 is accessed to determine (at 4311) if the symbol being examined has trend failure probability rate of less than 50% for the next higher time frame. If so, then the go-no-go counter is incremented (at 4306).

Then the permanent internal processing data store 1003 is accessed to determine (at 4312) if complimentary retest and regenerate signals across multiple time frames or confluent trends on the next higher time frame. If so, then the go-no-go counter is incremented (at 4306).

Then the permanent internal processing data store 1003 is accessed to determine (at 4313) if volume on the retest and regenerate sequence is less than volume on the breakout bar. If so, then the go-no-go counter is incremented (at 4306).

Then the permanent internal processing data store 1003 is accessed to determine (at 4314) if the break of the swing point was a confirmed breakout (volume was heavier on the breaking bar than the swing point bar). If so, then the go-no-go counter is incremented (at 4306).

Finally, the system memory 1040 is accessed to determine (at 4315) if the go-no-go counter is greater than or equal to six. If so, then the pertinent information regarding the potential trade is stored (at 4316) to the temporary internal processing data store 1002. Then the iterative loop 4301 continues for all other symbols.

Once all symbols are processed, the temporary internal processing data store 1002 is accessed to determine (at 4317) if any potential fast first retrace to the retest and regenerate zone trading signals were generated. If so, the fast the first retrace to the retest and regenerate zone trade setups are displayed to the end user via the display device 1080 and the process 4300 exits. Otherwise, the process 4300 just exits.

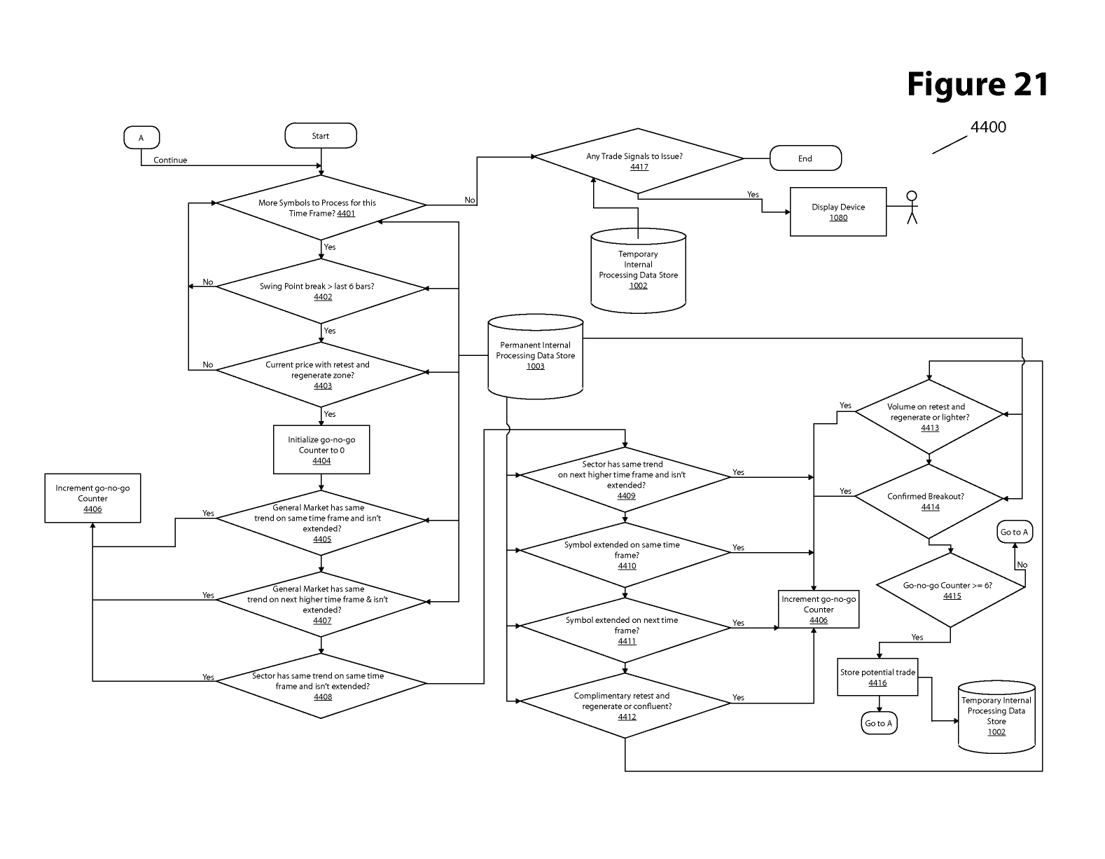

FIG. 21 describes, by way of conceptual process 4400, a novel method for algorithmically determining potential trading signals based on information created in FIG. 2-FIG. 13. FIG. 21 considers a decision tree for slow retrace trades. A slow retrace is a situation where a swing point break is followed by a retrace after more than six bars have transpired since the breakout. The trading signal is based on a number of criterions which, if enough are aligned, makes for a reasonably good probability that the trading signal has a higher probability of succeeding.

The process 4400 of FIG. 21 begins by entering into an iterative loop (at 4401) across all symbols in the permanent internal processing data store 1003 and examining each to see if they meet the trade setup criteria. The first criterion is to access the permanent internal processing data store 1003 to determine (at 4402) if the symbol has experienced a swing point break after more than six bars have passed. If not, the symbol is discarded and the iterative loop 4401 continues.

If so, then the permanent internal processing data store 1003 is accessed to determine (at 4403) if the current price for the symbol is within the high (if a breakout in an uptrend) or the low (if a breakout in a downtrend). If not, the symbol is discarded and the iterative loop 4401 continues.

If the decision process reaches this point, the decision as to whether to issue a trading signal for this symbol is based on having six or more, preferably seven, of the next nine decision criterions being realized. Some embodiment may have more decision criterions and the issuance of a trading signal may be based on realizing about eighty percent of the decision criterions in such embodiments.

To start this determination, the process 4400 initializes (at 4404) a go-no-go counter in system memory 1040 that keeps track of how many decision criterion matches to zero. Next, the permanent internal processing data store 1003 is accessed to determine (at 4405) if the general market is aligned for the same time frame and trend failure probability rates is less than 50%. If so, then the go-no-go counter is incremented (at 4406).

Then the permanent internal processing data store 1003 is accessed to determine (at 4407) if the general market is aligned for the next higher time frame and trend failure probability rates is less than 50% 4407. If so, then the go-no-go counter is incremented (at 4406).

Then the permanent internal processing data store 1003 is accessed to determine (at 4408) if the sector is aligned for the same time frame and trend failure probability rates is less than 50%. If so, then the go-no-go counter is incremented (at 4406).

Then the permanent internal processing data store 1003 is accessed to determine (at 4409) if the sector is aligned for the next higher time frame and trend failure probability rates is less than 50%. If so, then the go-no-go counter is incremented (at 4406).

Then the permanent internal processing data store 1003 is accessed to determine (at 4410) if the symbol being examined has trend failure probability rate of less than 50% for the current time frame. If so, then the go-no-go counter is incremented (at 4406).

Then the permanent internal processing data store 1003 is accessed to determine (at 4411) if the symbol being examined has trend failure probability rate of less than 50% for the next higher time frame. If so, then the go-no-go counter is incremented (at 4406).

Then the permanent internal processing data store 1003 is accessed to determine (at 4412) if complimentary retest and regenerate signals across multiple time frames or confluent trends on the next higher time frame. If so, then the go-no-go counter is incremented (at 4406).

Then the permanent internal processing data store 1003 is accessed to determine (at 4413) if volume on the retest and regenerate sequence is less than volume on the breakout bar If so, then the go-no-go counter is incremented (at 4406).

Then the permanent internal processing data store 1003 is accessed to determine (at 4414) if the break of the swing point was a confirmed breakout (volume was heavier on the breaking bar than the swing point bar). If so, then the go-no-go counter is incremented (at 4406).

Finally, the system memory 1040 is accessed to determine (at 4415) if the go-no-go counter is greater than or equal to six. If so, then the pertinent information regarding the potential trade is stored (at 4416) to the temporary internal processing data store 1002. Then the iterative loop 4401 continues for all other symbols.

Once all symbols are processed, the temporary internal processing data store 1002 is accessed to determine (at 4417) if any potential first retrace to the retest and regenerate zone trading signals were generated. If so, the slow retrace to the retest and regenerate zone trade setups are displayed to the end user via the display device 1080 and the process 4400 exits. Otherwise, the process 4400 just exits.

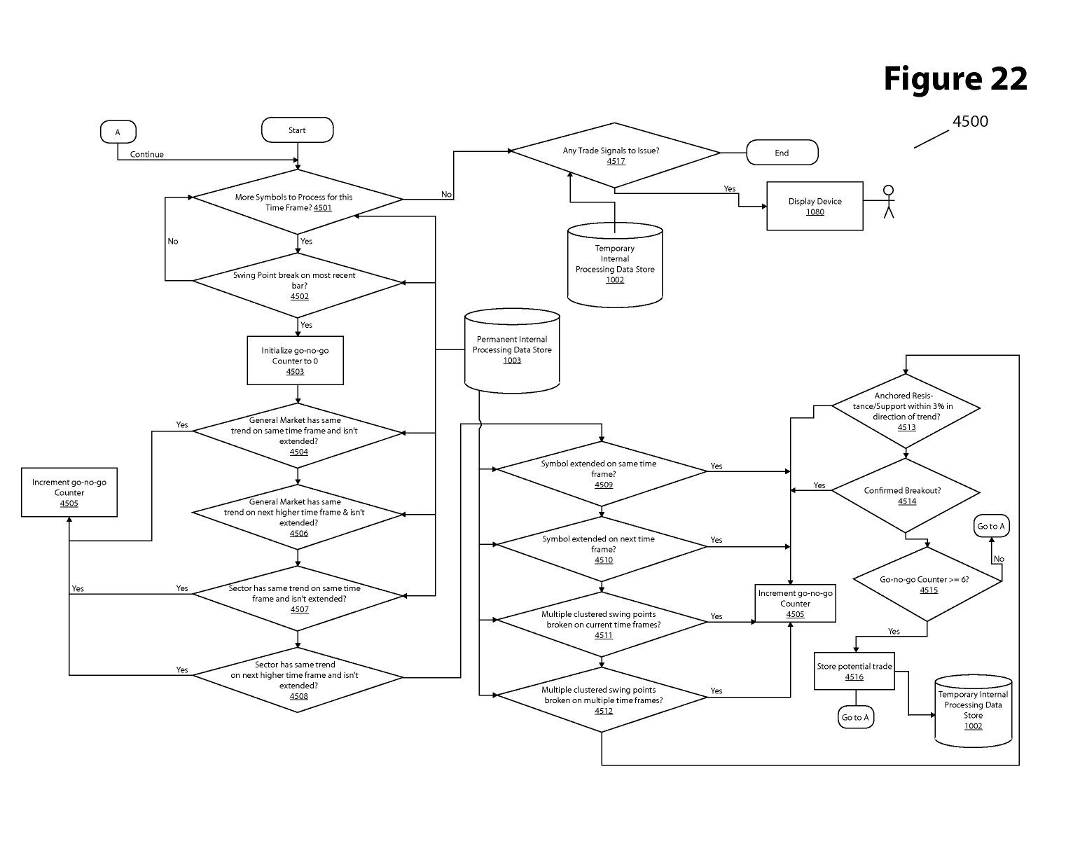

FIG. 22 describes, by way of conceptual process 4400, a novel method for algorithmically determining potential trading signals based on information created in FIG. 2-FIG. 13. FIG. 22 considers a decision tree for breakout trades. A breakout is a situation where a swing point is broken. The trading signal is based on a number of criterions which, if enough are aligned, makes for a reasonably good probability that the trading signal has a higher probability of succeeding.

The process 4500 of FIG. 22 begins by entering into an iterative loop (at 4501) across all symbols in the permanent internal processing data store 1003 and examining each to see if they meet the trade setup criteria. The first criterion is to access the permanent internal processing data store 1003 to determine (at 4502) if the symbol has experienced a swing point break on the final bar (most recently added bar from a time perspective) in the data store for this symbol. If not, the symbol is discarded and the iterative loop 4501 continues.

If the decision process reaches this point, the decision as to whether to issue a trading signal for this symbol is based on having six or more, preferably seven, of the next nine decision criterions being realized. Some embodiment may have more decision criterions and the issuance of a trading signal may be based on realizing about eighty percent of the decision criterions in such embodiments.

To start this determination, the process 4500 initializes (at 4503) a go-no-go counter in system memory 1040 that keeps track of how many decision criterion matches to zero. Next access the permanent internal processing data store 1003 to determine (at 4504) if the general market is aligned for the same time frame and trend failure probability rates is less than 50%. If so, then the go-no-go counter is incremented (at 4505).

Then the permanent internal processing data store 1003 is accessed to determine (at 4506) if the general market is aligned for the next higher time frame and trend failure probability rates is less than 50%. If so, then the go-no-go counter is incremented (at 4505).

Then the permanent internal processing data store 1003 is accessed to determine (at 4507) if the sector is aligned for the same time frame and trend failure probability rates is less than 50%. If so, then the go-no-go counter is incremented (at 4505).

Then the permanent internal processing data store 1003 is accessed to determine (at 4508) if the sector is aligned for the next higher time frame and trend failure probability rates is less than 50%. If so, then the go-no-go counter is incremented (at 4505).

Then the permanent internal processing data store 1003 is accessed to determine (at 4509) if the symbol being examined has trend failure probability rate of less than 50% for the current time frame. If so, then the go-no-go counter is incremented (at 4505).

Then the permanent internal processing data store 1003 is accessed to determine (at 4510) if the symbol being examined has trend failure probability rate of less than 50% for the next higher time frame. If so, then the go-no-go counter is incremented (at 4505).

Then the permanent internal processing data store 1003 is accessed to determine (at 4511) if multiple clustered swing points are broken for the current time frame under examination. If so, then the go-no-go counter is incremented (at 4505).

Then the permanent internal processing data store 1003 is accessed to determine (at 4512) if multiple clustered swing points are broken on multiple time frames for this symbol. If so, then the go-no-go counter is incremented (at 4505).

Then the permanent internal processing data store 1003 is accessed to determine (at 4513) if anchored resistance (if an uptrend) or anchored support (if a downtrend) exists just beyond the current price point where “current” is defined as within 3% of the current price point. If so, then the go-no-go counter is incremented (at 4505).

Then the permanent internal processing data store 1003 is accessed to determine (at 4514) if the break of the swing point was a confirmed breakout (volume was heavier on the breaking bar than the swing point bar). If so, then the go-no-go counter is incremented (at 4505).

Finally, the system memory 1040 is accessed to determine (at 4515) if the go-no-go counter is greater than or equal to six. If so, then the pertinent information regarding the potential trade is stored (at 4516) to the temporary internal processing data store 1002. Then the iterative loop 4501 continues for all other symbols.

Once all symbols are processed, the temporary internal processing data store 1002 is accessed to determine (at 4517) if any potential first retrace to the retest and regenerate zone trading signals were generated. If so, the breakout trade setups are displayed to the end user via the display device 1080 and the process 4500 exits. Otherwise, the process 4500 just exits.

Many of the above-described processes, modules, and interfaces are implemented as software processes that are specified as a set of instructions recorded on a computer readable storage medium (also referred to as “computer readable medium”, “readable storage medium”, or “machine readable medium”). When these instructions are executed by one or more computational element(s) (such as processors or other computational elements like ASICs and FPGAs), they cause the computational element(s) to perform the actions indicated in the instructions. Computer is meant in its broadest sense, and can include any electronic device with a processor. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant in its broadest sense. It can include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs when installed to operate on one or more computer systems define one or more specific machine implementations that execute and perform the operations of the software programs.

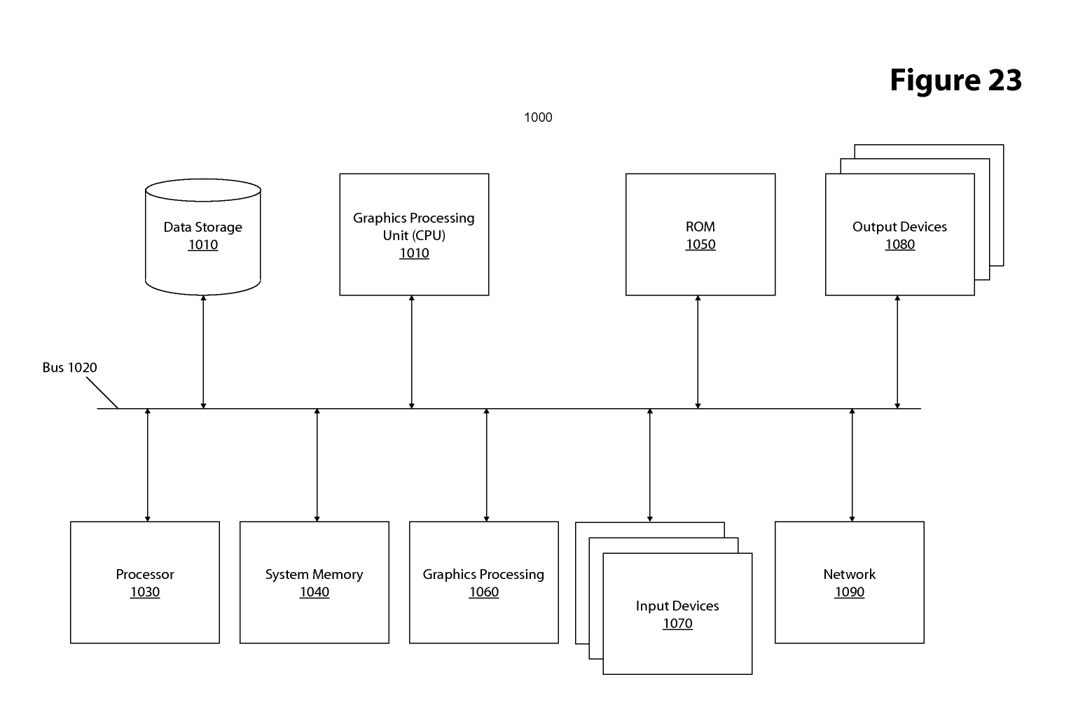

FIG. 23 conceptually illustrates a computer system 1000 with which some embodiments of the invention are implemented. For example, the system described above in reference to FIG. 2 may be at least partially implemented using sets of instructions that are run on the computer system 1000. As another example, the processes described in reference to FIGS. 3-22 may be at least partially implemented using sets of instructions that are run on the computer system 1000.

One of ordinary skill in the art will recognize that the computer system 1000 may be embodied in other specific forms without deviating from the spirit of the invention. For instance, the computer system may be implemented using various specific devices either alone or in combination. For example, a local PC may include the input devices 1070 and output devices 1080, while a remote PC may include the other devices 1010-1060, with the local PC connected to the remote PC through a network that the local PC accesses through its network connection 1090 (where the remote PC is also connected to the network through a network connection).

The bus 1020 collectively represents all system, peripheral, and chipset buses that communicatively connect the numerous internal devices of the computer system 1000. For instance, the bus 1020 communicatively connects the processor 1030 with the system memory 1040, the ROM 1050, and the permanent storage device 1010. From these various memory units, the processor 1030 retrieves instructions to execute and data to process in order to execute the processes of the invention. In some embodiments, the processor comprises a Field Programmable Gate Array (FPGA), an ASIC, or various other electronic components for executing instructions. In some cases, the bus 1020 may include wireless and/or optical communication pathways in addition to or in place of wired connections. For example, the input devices 1070 and/or output devices 1080 may be coupled to the system 1000 using a wireless local area network (W-LAN) connection, Bluetooth®, or some other wireless connection protocol or system.

The ROM 1050 stores static data and instructions that are needed by the processor 1030 and other modules of the computer system. The permanent storage device 1010, on the other hand, is a read-and-write memory device. This device is a non-volatile memory unit that stores instructions and data even when the computer system 1000 is off. Some embodiments of the invention use a mass-storage device (such as a magnetic or optical disk and its corresponding disk drive) as the permanent storage device 1010.

Other embodiments use a removable storage device (such as a floppy disk, flash drive, or CD-ROM) as the permanent storage device Like the permanent storage device 1010, the system memory 1040 is a read-and-write memory device. However, unlike storage device 1010, the system memory 1040 is a volatile read-and-write memory, such as a random access memory (RAM). The system memory stores some of the instructions and data that the processor needs at runtime. In some embodiments, the sets of instructions used to implement the invention's processes are stored in the system memory 1040, the permanent storage device 1010, and/or the read-only memory 1050. For example, the various memory units include instructions for processing multimedia items in accordance with some embodiments. From these various memory units, the processor 1030 retrieves instructions to execute and data to process in order to execute the processes of some embodiments.

In addition, the bus 1020 connects to the graphical processing unit (GPU) 1060. The GPU of some embodiments performs various graphics processing functions. These functions may include display functions, rendering, compositing, and/or other functions related to the processing or display of graphical data.

The bus 1020 also connects to the input devices 1070 and output devices 1080. The input devices 1070 enable the user to communicate information and select commands to the computer system. The input devices include alphanumeric keyboards and pointing devices (also called “cursor control devices”). The input devices also include audio input devices (e.g., microphones, MIDI musical instruments, etc.) and video input devices (e.g., video cameras, still cameras, optical scanning devices, etc.). The output devices 1080 include printers, electronic display devices that display still or moving images, and electronic audio devices that play audio generated by the computer system. For instance, these display devices may display a GUI. The display devices include devices such as cathode ray tubes (“CRT”), liquid crystal displays (“LCD”), plasma display panels (“PDP”), surface-conduction electron-emitter displays (alternatively referred to as a “surface electron display” or “SED”), etc. The audio devices include a PC's sound card and speakers, a speaker on a cellular phone, a Bluetooth® earpiece, etc. Some or all of these output devices may be wirelessly or optically connected to the computer system.

Finally, as shown in FIG. 23, the bus 1020 also couples computer 1000 to a network 1090 through a network adapter (not shown). In this manner, the computer can be a part of a network of computers (such as a local area network (“LAN”), a wide area network (“WAN”), an Intranet, or a network of networks, such as the Internet. For example, the computer 600 may be coupled to a web server (network 1090) so that a web browser executing on the computer 1000 can interact with the web server as a user interacts with a GUI that operates in the web browser.

As mentioned above, the computer system 1000 may include electronic components, such as microprocessors, storage and memory that store computer program instructions in one or more of a variety of different computer-readable media (alternatively referred to as computer-readable storage media, machine-readable media, machine-readable storage media, readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ZIP® disks, read-only and recordable blu-ray discs, ultra density optical discs, any other optical or magnetic media, and floppy disks. The computer-readable media may store a computer program that is executable by at least one processor and includes sets of instructions for performing various operations. Examples of hardware devices configured to store and execute sets of instructions include, but are not limited to application specific integrated circuits (ASICs), field programmable gate arrays (FPGA), programmable logic devices (PLDs), ROM, and RAM devices. Examples of computer programs or computer code include machine code, such as produced by a compiler, and files including higher-level code that are executed by a computer, an electronic component, or a microprocessor using an interpreter.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals. It should be recognized by one of ordinary skill in the art that any or all of the components of computer system 1000 may be used in conjunction with the invention. Moreover, one of ordinary skill in the art will appreciate that any other system configuration may also be used in conjunction with the invention or components of the invention.

While the invention has been described with reference to numerous specific details, one of ordinary skill in the art will recognize that the invention can be embodied in other specific forms (i.e., different embodiments may implement or perform different operations) without departing from the spirit of the invention. One of ordinary skill in the art would also recognize that some embodiments may divide a particular module into multiple modules. In addition, although the examples given above may discuss accessing the system using a particular device (e.g., a PC), one of ordinary skill will recognize that a user could access the system using alternative devices (e.g., a cellular phone, PDA, smartphone, BlackBerry®, or other device).

One of ordinary skill in the art will realize that, while the invention has been described with reference to numerous specific details, the invention can be embodied in other specific forms without departing from the spirit of the invention. One of ordinary skill in the art would understand that the invention is not to be limited by the foregoing illustrative details, but rather is to be defined by the appended claims.

I claim:

1. A non-transitory computer readable medium storing a computer program which when executed by at least one processor provides a graphical presentation of trading data, the computer program comprising sets of instructions for:
receiving an input of a stock symbol;
determining a short term qualified trend for the stock symbol;
determining an intermediate term qualified trend for the stock symbol;
determining a long term qualified trend for the stock symbol;
determining a short term qualified trend for the sector of the stock symbol;
determining an intermediate term qualified trend for the sector of the stock symbol;
determining a long term qualified trend for the sector of the stock symbol;
determining a short term qualified trend for the overall market of the stock symbol;
determining an intermediate term qualified trend for the overall market of the stock symbol;
determining a long term qualified trend for the overall market of the stock symbol; and
displaying a three by three matrix, wherein the matrix displays the qualified trend for (i) the received stock symbol, (ii) the sector of the stock symbol, and (iii) the overall market of the stock symbol over three different time frames, wherein the three time frames consist of a short term, an intermediate term, and a long term time frame.

2. The non-transitory computer readable medium of claim 1 further comprising sets of instructions for:
determining a short term failure probability rate for the short term qualified trend of the stock symbol;
determining an intermediate term failure probability rate for the intermediate term qualified trend of the stock symbol;
determining a long term failure probability rate for the long term qualified trend of the stock symbol;
determining a short term failure probability rate for the short term qualified trend of the sector of the stock symbol;
determining an intermediate term failure probability rate for the intermediate term qualified trend of the sector of the stock symbol;
determining a long term failure probability rate for the long term qualified trend of the sector of the stock symbol;
determining a short term failure probability rate for the short term qualified trend of the overall market of the stock symbol;
determining an intermediate term failure probability rate for the intermediate term qualified trend of the overall market of the stock symbol;
determining a long term failure probability rate for the long term qualified trend of the overall market of the stock symbol; and
displaying, in the three by three matrix, failure probability rates for (i) the received stock symbol, (ii) the sector of the stock symbol, and (iii) the overall market of the stock symbol over three different time frames, wherein the three time frames consist of a short term, an intermediate term, and a long term time frame.

3. The non-transitory computer readable medium of claim 1, wherein short term determinations are made based on a time frame of three month.

4. The non-transitory computer readable medium of claim 1, wherein intermediate term determinations are made based on a time frame of nine month.

5. The non-transitory computer readable medium of claim 1, wherein short term determinations are made based on a time frame of three years.

6. The non-transitory computer readable medium of claim 1 further comprising sets of instructions for displaying confirmed trends in a first color to visually indicate confirmed trends.

7. The non-transitory computer readable medium of claim 1 further comprising sets of instructions for displaying suspect trends in a second color to visually indicate suspect trends.

8. A non-transitory computer readable medium storing a computer program which when executed by at least one processor provides a graphical presentation of trading data, the computer program comprising sets of instructions for:
determining a qualified trend for swing point high break data bars of a trading instrument;
determining a qualified trend for swing point low break data bars of a trading instrument;
storing an overall qualified trend of the trading instrument as one of bullish, bearish, or sideways; and
storing, the overall qualified trend of the trading instrument as one of a confirmed or suspect trend; and
displaying three different qualified trends of the trading instrument in a matrix, wherein the qualified trend is determined for three different time frames, wherein the three time frames consist of a short term, an intermediate term, and a long term time frame.

9. The non-transitory computer readable medium of claim 8, wherein the determining of the qualified trend for swing point high break data bars comprises:
initializing a prior trend as ambivalent;
reading all broken swing point high bars from an internal processing data store;
determining a volume of a bar that broke the swing point high bar as being greater than the broken swing point high bar;
determining that the prior trend of the broken swing point high bar is either (i) one of ambivalent, suspect sideways, or confirmed sideways or (ii) not one of ambivalent, suspect sideways, or confirmed sideways and not one of suspect bearish or confirmed bearish; and
classifying the qualified trend as confirmed bullish.

10. The non-transitory computer readable medium of claim 8, wherein the determining of the qualified trend for swing point high break data bars comprises:
initializing a prior trend as ambivalent;
reading all broken swing point high bars from an internal processing data store;
determining a volume of a bar that broke the swing point high bar as being greater than the broken swing point high bar;
determining that the prior trend of the swing point high bar is not one of ambivalent, suspect sideways, or confirmed sideways;
determining that the prior trend of the broken swing point high bar is suspect bearish or confirmed bearish; and
classifying the qualified trend as confirmed sideways.

11. The non-transitory computer readable medium of claim 8, wherein the determining of the qualified trend for swing point high break data bars comprises:
initializing a prior trend as ambivalent;
reading all broken swing point high bars from an internal processing data store;
determining a volume of a bar that broke the swing point high bar as being less than the broken swing point high bar;
determining that the prior trend of the broken swing point high bar is either (i) one of ambivalent, suspect sideways, or confirmed sideways or (ii) not one of ambivalent, suspect sideways, or confirmed sideways and not one of suspect bullish or confirmed bullish; and
classifying the qualified trend as suspect bullish.

12. The non-transitory computer readable medium of claim 8, wherein the determining of the qualified trend for swing point high break data bars comprises:
initializing a prior trend as ambivalent;
reading all broken swing point high bars from an internal processing data store;
determining a volume of a bar that broke the swing point high bar as being less than the broken swing point high bar;
determining that the prior trend of the broken swing point high bar is not one of ambivalent, suspect sideways, or confirmed sideways;
determining that the prior trend of the broken swing point high bar is suspect bullish or confirmed bullish; and
classifying the qualified trend as suspect sideways.

13. The non-transitory computer readable medium of claim 8, wherein the determining of the qualified trend for swing point high break data bars comprises:
initializing a prior trend as ambivalent;
reading all broken swing point high bars from an internal processing data store;
determining a volume of a bar that broke the swing point high bar as being equal to the broken swing point high bar; and
classifying the qualified trend with the value of the prior trend of the broken swing point high bar.

14. The non-transitory computer readable medium of claim 8, wherein the determining of the qualified trend for swing point low break data bars comprises:
initializing a prior trend as ambivalent;
reading all broken swing point low bars from an internal processing data store;
determining a volume of a bar that broke the swing point low bar as being greater than the broken swing point low bar;
determining that the prior trend of the broken swing point low bar is either (i) one of ambivalent, suspect sideways, or confirmed sideways or (ii) not one of ambivalent, suspect sideways, or confirmed sideways and not one of suspect bullish or confirmed bullish; and
classifying the qualified trend as confirmed bearish.

15. The non-transitory computer readable medium of claim 8, wherein the determining of the qualified trend for swing point low break data bars comprises:
initializing a prior trend as ambivalent;
reading all broken swing point low bars from an internal processing data store;
determining a volume of a bar that broke the swing point low bar as being greater than the broken swing point low bar;
determining that the prior trend of the swing point low bar is not one of ambivalent, suspect sideways, or confirmed sideways;
determining that the prior trend of the broken swing point high bar is suspect bullish or confirmed bullish; and
classifying the qualified trend as confirmed sideways.

16. The non-transitory computer readable medium of claim 8, wherein the determining of the qualified trend for swing point low break data bars comprises:
initializing a prior trend as ambivalent;
reading all broken swing point low bars from an internal processing data store;
determining a volume of a bar that broke the swing point low bar as being less than the broken swing point low bar;
determining that the prior trend of the broken swing point low bar is either (i) one of ambivalent, suspect sideways, or confirmed sideways or (ii) not one of ambivalent, suspect sideways, or confirmed sideways and not one of suspect bullish or confirmed bullish; and
classifying the qualified trend as suspect bearish.

17. The non-transitory computer readable medium of claim 8, wherein the determining of the qualified trend for swing point low break data bars comprises:
initializing a prior trend as ambivalent;
reading all broken swing point low bars from an internal processing data store;
determining a volume of a bar that broke the swing point low bar as being less than the broken swing point low bar;
determining that the prior trend of the broken swing point low bar is not one of ambivalent, suspect sideways, or confirmed sideways;
determining that the prior trend of the broken swing point low bar is suspect bullish or confirmed bullish; and
classifying the qualified trend as suspect sideways.

18. The method of claim 17 further comprising:
transmitting the transaction details to a merchant service provider for authorizing a charge to a consumer credit card;
receiving validation of the charge; and
displaying a confirmation of items purchased within the single frame video display area to the consumer.

19. The non-transitory computer readable medium of claim 8, wherein the determining of the qualified trend for swing point low break data bars comprises:
initializing a prior trend as ambivalent;
reading all broken swing point low bars from an internal processing data store;
determining a volume of a bar that broke the swing point low bar as being equal to the broken swing point low bar; and
classifying the qualified trend with the value of the prior trend of the broken swing point low bar.

20. The non-transitory computer readable medium of claim 8 further comprising:
determining a trend's mean time to failure by capturing the cumulative probability of a trend's failure rate bar-by-bar; and
displaying three different mean time to failure rates for the trading instrument in the matrix for each of the three time frames.
